(19) United States
(12) Patent Application Publication
(10) Pub. No.: US 2019/0332983 A1
(43) Pub. Date: Oct. 31, 2019

(54) Legal intelligence credit business: a business operation mode of artificial intelligence + legal affairs + business affairs

(71) Applicants: Ahe Li, Tongling (CN); Xianda Li, Beijing (CN); Hongyun Ren, Tongling (CN); Jiaxin Li, Lu'an (CN); Yong Li, Lu'an (CN); Yangyang Zhang, Qinhuangdao (CN); Yuanyuan Li, Lu'an (CN)

(72) Inventors: Ahe Li, Tongling (CN); Xianda Li, Beijing (CN); Hongyun Ren, Tongling (CN); Jiaxin Li, Lu'an (CN); Yong Li, Lu'an (CN); Yangyang Zhang, Qinhuangdao (CN); Yuanyuan Li, Lu'an (CN)

(21) Appl. No.: 16/508,240

(22) Filed: Jul. 10, 2019

(30) Foreign Application Priority Data
Dec. 10, 2018 (SG) 10201811045W

(51) Int. Cl. G06Q 10/06; G06N 20/00

(52) U.S. Cl. CPC G06Q 10/067; G06N 20/00

(57) ABSTRACT

The present invention discloses a business operation mode based on artificial-intelligence+legal-affairs+business-affairs. AI is the empowerment, legal-affairs' main-body, business-affairs' framework. AI characteristics lie-in two-learning or two-experts, including Internet-of-human, Internet-of-things, Internet-of-intelligence; applying AI computer-program to control or improve business-quality. AI+legal-affairs innovation lies-in new-brain or new-procedures, using contract to authorize AI's basic-role in judicial-affairs. Identification or adjudication is made by deep-learning and reinforcement-learning, both priorities accept. Experts separately verify evidence or fact, video-trial, mediate then arbitrate. Expert-database complements expert-system each-other, explains algorithm, and promotes reconciliation. Financial-experts control credit-limit and perform-contract through guarantee insurance. AI+legal-affairs+business-affairs characteristics lie-in two-lines or two-supports, applying AI to verify the credit of excellent business-subjects or business-quality, and control to improve business-process. To improve business-quality, focuses are on AI-health, AI-teaching, AI-traffic, or other public-services.

### CROSS REFERENCE OF RELATED APPLICATION

The present invention claims priority under 35 U. S. C. 119(a-d) to SG 10201811045W, filed Dec. 10, 2018.

### BACKGROUND OF THE PRESENT INVENTION

### Field of the Present Invention

The present invention relates to a computer program of artificial intelligence, and specifically relates to a business operation mode based on the artificial intelligence+legal affairs+business affairs.

### Description of Related Arts

I. The quality of goods services in countries around the world, the most regrettable is the quality of legal services. 1. Misjudgment too much. German criminal misjudgment is up to ¼; the United States' error rate in death sentences in 1973-1995 was 68% (a major error in appeals was sent back for retrial). In Germany in 1996, the civil appeal change rate was 36-40% and the return rate was 5%. 2. Time too long. In the UK in 1996, the average case closing time was 161 weeks in London and 195 weeks outside London. 3. Cost too high. In the U.S. in 1991, 90% of the cases in the 12 states of the United States were concluded within two years, and 50% of the cases in the other three states exceeded two years. In the U.S. and the U. K., lawyers charge more than the small amount of litigation. In the U. K., in 1995-2000, only the winning party had the judgment cost of charging bills, accounting for 115-174% of the litigation subject of less than £12. 5 million (174% represents 261% of the litigation target). 4. Dissatisfaction too High. In France in 1991, the people's dissatisfaction rate to justice reached 83-97%. China has also witnessed many unjust cases, such as Shubin Nie, Gillettu Huge, Xianglin She, Zuohai Zhao, Jiuming Li and Peiwu Du, which have been difficult to safeguard rights and correct mistakes, and have harmed citizens' confidence. Civil cases are soaring and piling up. Letters and visits do not believe in law, and the cost of maintaining stability is high. The absence of social governance, the lack of an effective mechanism to resolve disputes, that make it difficult for reconciliation to be final, mediation to be successful, arbitration to be impartial . . . that influence social integrity, transaction costs.

See the “Final Report on the Structure Reform of the Civil Court” by Lord Justice Briggs of the British Court of Appeal, the “Civil Justice in Crisis: A Comparative Perspective of Civil Procedure”, edited by Professor Zuckerman of Oxford University, UK, the “Failure of Justice: Apocalypse of Miscarriage of Justice in Germany”, Dr. Dam Stout, Germany, The investigation report of Columbia. University Law School, US “A Broken System: Error Rates in Capital Cases (1973-1995)” so on. The comparative study found that: The first is the lack of effective application of AI. Conventionally, Alternative dispute resolution (ARD), Online Dispute Resolution System (ODR), Intellectual court, and Internet courts, etc., neither apply scientific and technological means to solve the justice problem of reality, time and cost; nor solved the problem of identification true facts through post-event evidence. The second is lack of effective participation of experts. The juries and jurors in various regions didn't learn from professional expertise and practical experience of business experts. Neither solve the problem of the ability to understand evidence fact of cross-majors and lack of practice, nor solve the problem of local protection, interpersonal public relations and personal emotions. The key is that the industry has specialty, no to judge the calabash case by the calabash monk.

AI's rapid calculation +market competition can solve the problem of time delay in justice. AI+online video+market competition can solve the problem of high cost of justice. AI's synchronous deposit of data evidence+deep learning of human experience+intensive learning of scientific logic, can prevent and cure too many problems of judicial misjudgment. Business experts' grading verification of evidence fact and legal experts' algorithmic adjudication, can solve too many problems of judicial misjudgment.

II. The quality problems of goods services in various countries in the world lack of effective legal guarantees, to cause problems such as transaction costs, social integrity, and national development.

1. The main problems of e-commerce physical-stores are false propaganda, counterfeit and shoddy, difficult to distinguish and regret the choice, etc.; too many quality disputes, mediation and difficult to resolve, especially the quality and quantity of drugs and food safety issues. The physical business stores have good experience, high quality, less disputes; high cost, difficult survival and slow integration.

2. The main problems of Education training problem, in China are lack of teaching in accordance with their aptitude, elite youth, innovative talents; lack of multiculturalism, multi-industry experience, and global vision; the content of courses being not unified and standardized, not organized and simplified, more courses and more difficult selection; learning time-consuming, slow results; too disputes being difficult to solve.

3. The main problems of health care, in china are unreasonable allocation of resources between urban and rural, public fund on over-examination, over-prescription, inflated drug prices, and using drugs to support medical care, etc.; self-funded, sick is difficult to cure, returning to poverty due to illness; rampant medical corruption, unbelief in official identification, frequent occurrence of medical injuries, and difficulties in mediation.

4. The main problems of transportation, in China are congestion, difficult to get out and park; especially in big cities, and the commute wastes 2-3 hours per day; unmanned driving technology cannot solve the problem of insufficient space in the road garage; traffic accidents are frequent and the resolution mechanism is not smooth.

The comparative study found that: The first is the lack of effective application of AI. The limitations of human beings such as profession, practice, forgetting, and emotions cannot overcome. The Second is lack of expert participation, The authentication of professional evidence and business facts only depends on the subjective free heart evidence of lack of business expertise after the fact. The third is lack of combination of the AI and legal affairs. It is lack of synchronous data evidence, without synchronization to business activities and key links.

AI+legal affairs+Business affairs mode extends to whole processes and key links of business, can control or improve the responsibility capacity and operation process of business subjects and so on, can control or improve the main body ability and service process of medical treatment, education, transportation, etc., so as to improve the quality of goods services; can solve the problems such as counterfeit and shoddy goods, food safety, drug quality, to facilitate solving the difficulties of the poor in medical treatment, education, and transportation, and to facilitate solving the problems of judicial justice.

III. Germany's 2001 the “Civil Litigation Reform Act”, Japan's 2004 the “Law on Promoting Out-Trial Dispute Resolution Procedures”, The US's 2015 “Outline of Federal Judicial Reform”, The UK's 2016 “Final Report on the Reform of Civil Court Structure”, In recent years, China's “Opinions on Improving the Diversified Solution Mechanism of Contradictions and Disputes”, “Opinions on Further Deepening the Reform of Diversified Dispute Resolution Mechanisms by the People's Court”, “Opinions on Conducting Lawyers' mediation Pilot Work”, etc. In particular, the “abandon human experience” pure “self-training” reinforcement learning algorithm identified by Alpha Go Zero in October 2017, provides a better social and technological environment for the AI+legal affairs+business affairs social governance and business operation mode.

This social governance and business operation mode will replace the traditional mode, and will focus on operations in Europe and the United States, and will continue to be simplified with the advancement of science and technology.

### SUMMARY OF THE PRESENT INVENTION

The present invention provides a solution to control or improve the operational process of goods services by executing an artificial intelligence computer program. The purpose of the program is o solve the technical problem of how to apply AI technology to improve the quality of Goods services (including legal services). The method is to realize the control or improvement of the business affairs and legal affairs operation process by executing computer program with applying AI technical means and legal means; especially AI verification and due diligence of the credit qualification of business subjects, AI divide-professional and three-grade verification of business evidence fact, and the AI+experts' reconciliation, etc. Reflection is the technical quality standards and technical specifications. Utilization is the technical means to follow the laws of nature. It achieves the technical effects of AI software and hardware, improve business quality, save business time, reduce transaction cost and improve social credibility, etc., in line with natural laws.

The business operation mode provide AI targeted selection services such as social-intercourse, information, video, live-broadcast, entertainment, games, payment, study, travel, new-retail, life-services, linking legal or business featured services; integrate international, domestic, self-operated, other-operated, e-commerce, store businesses, goods, services; prominent the innovation of the legal mode; light assets, heavy talents, heavy mechanisms; revenue priority to commission, promotion, value-added; details are shown in embodiment 3.

An application of the technical solution comprises 1 system, 3 sub-systems and 13 modules, wherein there are three levels of features comprising:

Foremost macroscopically, relationship characteristics of the three subsystems are as follows: the AI is an empowering platform, legal innovation is a subject soul, business integration is a body frame, and the business quality is an ultimate goal.

Next mesoscopically, the characteristics of novelty, creativity and practicability of the three subsystems are as follows: improving of the AI lies in “double learning” or “double experts”, innovation of legal services lies in the “new brain” or the “new procedures”, improving of goods services lies in “two lines” or “two supports”.

Third microscopically, looking from the perspective of connecting of three networks of Internet of human, Internet of things, Internet of intelligence, and superposition of AI, legal affairs, business affairs, the technical solution is characterized by improvement on popular universal technology (No need to elaborate), as detailed in claims 2(8)(9)(10), 4(7)(8)(9), 11(6)(7)(8).

The technical means utilized in the technical solution are: deep learning, reinforcement learning, computational law, algorithmic adjudication, expert system, intelligent search, fingerprint recognition, face recognition, speech recognition, video recognition, electronic identification, image interpretation, language and image understanding, genetic programming, gaming, automatic programming, intelligent control, Internet of Human, Internet of Things, Internet of intelligence, large data, cloud computing, location navigation, video communications, etc.; details are shown in FIGS. 1, 2, 3, 4, and embodiments 1, 2, 4, 5;

In summary, the characteristics of this business mode technology solution can be summarized as follows:

(1) Artificial intelligence: The AI is the empowering platform, the improving of AI lies in the “double learning” or the “double experts”;

(2) AI+legal affairs: The legal innovation is the subject soul, the innovation of legal services lies in the “new brain” or the “new procedures”;

(3) AI+legal affairs+business affairs: The business integration is the body frame, the business quality is the ultimate goal, the improving of business service lies in the “two lines” or the “two supports”.

I. Provide AI Computer Programs:

Provide the Empowering Platform to Control or Improve the Quality of Goods Services

AI provides the brain of Internet of Things, with algorithms and industry rules engines to form logic, ideas, instructions, and tuning capabilities; Internet of things provides an AI neural network that provides information for perception, cognition, cloud computing and control. In the past, Internet was connected with people and people; in the cloud era, to enterprises, governments, etc., and also to people and things, in the future, help the various industries to establish a “super brain.”0 In cloud era, it is adjacent to people and people, people and things, people and doing things, the corresponding are Internet of Human, Internet of Things, Internet of Intelligence. The mode involved in three-net, featuring “double learning ” and “double experts”, has different contents and characteristics.

(I) Internet of Human:

Provides Verifying Modules for Qualification Credit Of Experts, Entrepreneurs, Consumer.

Internet provides a platform from “multi-user” to “all-user”, improving the interpersonal connectivity with connecting employees within enterprises and users within the government. providing a platform for trust and cooperation, and breaking information islands, such as intelligence government, intelligence retail, intelligence legal affairs, intelligence education, intelligence medical treatment, etc.

This mode applies the linking technology between people from the perspective of the subject, focusing on providing the qualification credit verification and due diligence investigation of experts and business subjects. The “all-user” platform, provided on the basis of individual and natural person, plus the feature value of “work unit”, constitutes the user group of B terminal and Ci terminal. According to the needs, add the feature value such as “specialty, education and title” to constitute expert database; add the feature value such as “expertise, industry and post” to constitute the user group such as production workers, waiters, entrepreneurs and other user groups. The main content and characteristics of this mode of Internet of Human are as follows.

1. Provide a Verification System for the Qualification Credit of Users and Experts.

Accumulate and analyze the “all-user” qualification credit data; first invite fine users with knowledge expertise and professional specialty to join the future expert group; then establish expert database through qualification credit verification, The expert database should be strictly graded according to genetic inheritance, EQ, IQ, professional testing, and performance evaluation; every year, it is also required strict grading promotion according to the professional ability update test and performance development evaluation; not only consider occupational and professional qualifications, but also consult income and expenditure, as well as honesty circumstance. Experts are responsible for the transparency and interpretability of AI.

2. Provide the Verification System for the Qualification Credit of Employees and Operators.

First invite fine users with professional technical expertise and organizational management advantages to establish a group of future technicians and bosses; then through the qualification and credit verification, establish fine craftsman and boss group. They are strictly divide-grade classified into groups according to EQ, IQ, professional testing, performance evaluation, and its technical advantages and talent system; each year are promoted according to competency test and performance evaluation; not only consider technical level, but also consult income and expenditure, as well as honesty circumstance. Employees and operators decide the quality of business, and can be a candidate for evidence expert database.

3. Provide the Verification System for the Qualification Credit of Enterprises and Entrepreneurs.

First invite enterprises and their executives with advantages of technology, quality and market to join the group of future enterprises and entrepreneurs; then through the qualification and credit verification, establish fine enterprises and entrepreneurs group. They are strictly divide-grade classified into groups according to the talent team, system mechanism, operating performance, user evaluation, EQ, IQ and professional ability test, they were classified into groups strictly; each year are promoted according to management evaluation; not only consider qualification abilities, but also consult income and expenditure, as well as honesty circumstance. Entrepreneurs decide the direction of the enterprise, and can be a candidate for the facts database.

The above fine users verification information of qualification and credit will be provided a briefing according to the requirements, for users to select the best; providing comprehensive due diligence services in accordance with the agreement between the parties and the progress of the transaction; providing accurate and shared information, and providing a platform for teaming exchanges, showing talents, and win-win transactions.

(II) Internet of Things:

Provides Tracking Modules for Control or Improving of Quality, Origin, or Operational Processes.

Internet of Things provides the connection between people and things. The core is not the thing, the core is the connection, and more about the intelligence; providing a deep connection between digital craftsmanship, lower-level cutting-edge technology, the physical world and the digital world; especially to improve the yield rate, reduce the loss rate, and optimize the manufacturing method.

This mode applies the link technology of people and things from the perspective of object. The quality of goods services depends on the control or improvement of the operation process; the object of the service is based on the natural person, and the all-user plus the “work unit” feature value constitutes the user group of B terminal. Provide quality “full process” control or improvement: provide control or improvement of the process of raw materials from planting, processing, transporting and selling; provide control or improvement of the process of service subjects' qualification and credit, education cultivation, service program, etc. The main contents and characteristics of this mode of Internet of Things are as follows.

1. Provide the Control System for Quality Standards and Identification Evaluation.

Providing AI list of high-quality goods and services, to increase links of standard comparison table and cost performance ranking; and increase recommendation and promotion service for high quality that meets or exceeds national and international standards. Providing credit qualification identification for fine enterprises, increase AI verification services for corporate governance, talent teams and due diligence. Enterprise online application, provision of qualification certificate, operation condition and other materials, to increase AI calculation, expert selection, and may apply for three-level verification. AI applying Internet of Human of the “all-user” accumulated credit qualification data, user evaluation, transaction data, increase verification, tracking services, and increase the provision of change charts; for the substandard business service, prompting purchase risk.

2. Provide the Control System for Origin and Production Operation Process.

Applying AI's process control and large data calculation, increase providing control and improving of the origin-planter's geographical location, soil environment, planting growth, harvesting and processing, sales and transporting, etc.; increase providing control and improving of processes such as manufacturers, raw material sources, production environments, processing and packaging, and transporting handover; increase providing control and improving of the process of sellers, source of goods, planting and produce, packaging and transporting, storage and delivery, etc. The focus of the nature will be traceable to prevent counterfeiting and shoddy,

3. Provide the Control System for Service Providers and Service Management Processes.

Applying AI process control and large data calculation, to provide information services of service providers such as qualification features, service fields, industry advantages, operation history, unique skills and user experience, to help compare and select the best. Provide information services of service experts and waiters, such as divide-professional and divide-grade, qualification, professional expertise, training exchanges, user evaluation, to help select customized services. Increase service control or improvement, such as environmental facilities, technical teams, expert selection, business procedures, etc., and guarantee service quality and choice.

The focus of the future is to be traceable. Carrying forward the spirit of digital craftsmanship, mastering more underlying cutting-edge technologies, provide deeper connection services; specially applying Internet technology, provide services to improve the rate of good products, reduce loss wastage rate, optimize manufacturing methods. The concrete will gradually expand and develop in practice.

(III) Internet of Intelligence:

Provides Deep and Reinforcement “Double Learning”, Expert Database and System “Double Experts”.

The Super Brain provides an intelligent operating system for AI, providing the core capabilities of Internet of Intelligence. Internet of Intelligence is the product of the integration of Internet of Things and AI, providing intelligent application scenarios and application modes, to serves the real economy, and realizes the digitization and interconnection of all things.

The mode provides human-service link technology from the perspective of internet of Intelligence; provides the objective, scientific, non-subjective, uninterrupted service of super-human intelligence on the online super-brain and expert system, and provides the “double learning” characteristic application of deep learning of human experience and reinforcement learning of the scientific logic; at the same time, it provides the human intelligence service of grounding gas of the off-line expert database system, to improve transparency, interpretability and selectivity; and provides online and offline “double-expert” integration mutual assistance, features services. The main content and characteristics of this mode of internet of Intelligence are as follows.

1. Provide the Expert Database of Multi-National Multi-Professional Three-Grade.

Setting up three professional according to the evidence, fact and law of business, and evaluates three-grade as intermediate, advanced and super grade; to actualize specialization according to computer, finance, commerce and trade, production and so on, to conduct actual practice according to reconciliation, mediation or arbitration, adjudication and so on; entering the grading database according to academic knowledge, performance evaluation, EQ and IQ, professional test, and annual update evaluation and grading promotion. Providing a global database of experts can effectively avoid the impact of local protection and interpersonal researching, avoid colored glasses and cultural biases of different backgrounds. Details see I (I) 1, II (I) 4.

2. Provide Online and Offline “Double Expert” Cooperation System.

The online expert system cooperates with the offline expert database to help or complement each other with advantages. The expert system refers to the computer intelligent program system with specialized knowledge and experience; the three components are expert-level knowledge in a certain application field, ability to simulate expert thinking, and ability to reach expert-level problem solving level, The expert database comprises intermediate, advanced and super experts in the fields of business evidence, facts and law; making transparent interpretation, helping users to understand and accept; conducting interval verification, making evidence verification, fact verification identification and legal adjudication.

3. Provide a Super-Brain “Double Learning” Contrast System.

When it comes to AI algorithms, parallel application the algorithm of reinforcement learning of scientific logic and deep learning of human experience, providing a most accurate and a most suitable interval; so convenient for the parties to choose to reconcile within the interval, The concepts and differences between reinforcement learning and deep learning are shown in FIG. 3, with attached figure instructions, on page 8. The characteristic process of “Double Learning, Double Experts” are shown in FIG. 1, with attached figure instructions.

The AI characteristics and core parts of this mode comprise user module, input module, reinforcement learning module and deep learning module, classification modeling module, combination module, output module and expert database module; successively through the procedures of service demand, information collection, analysis and processing, classification and integration, data reorganization, solutions, expert interpretation, and expert verification; especially expert persuasion, expert verification after the user does not understand, does not accept.

(1) The user inputs the service demand information from the input module to the system, and transmits it to a system of the AI legal affairs+business affairs, for collecting information about the user's needs;

(2) A reinforcement learning and deep learning module of the AI+legal affairs+business affairs system analyzes and processes the demand information according to the user's service requirements;

(3) The information processed by the reinforcement learning and deep learning module, is classified and integrated processing according to different types to form modular data;

(4) The system recombines different modularized data based on the combined module, and applies an adaptive algorithm to process to obtain solutions;

(5) The user reads a most accurate solution and a most suitable solution through the Output module of the system, giving priority to approbate and select;

(6) When the user does not approbate it, the three-grade experts make interpretation according to a contract to help the user understand, accept, then approbate and select;

(7) When the user fails to approbate it after the interpretation, the three-grade experts make verification according to the contract, then issues the verification or adjudication, and takes effect after delivery.

The focus of the future is to provide intelligent application scenarios and application modes, to provide deep integration of Internet of Things and AI, to provide intelligent applications through Internet of Things and large data analysis, and to promote and improve the real economy; it will be gradually launched and pioneered in practice. The concrete will unfold gradually and develop in practice.

II. Provide AI+Legal Affairs Computer Program:

Provide the Subject Soul to Control or Improve Business Affairs Quality

In order to improve the quality of legal affairs, on the basis of Internet of human expert database, it provides expert database such as business evidence, facts, laws, and carries on qualification credit verification with emphasis. On the basis of the operational process control of Internet of Things, it provides high-quality legal services with the digital craftsmanship and the underlying cutting-edge technology. In the flexible deployment of Internet of intelligence super-brain, it provides intelligent application scenarios and application modes; the innovation lies in the “new brain new program”, particularly it must consider the objective impact of different cultural traditions and industry habits.

(I) Special Contract Terms:

Provide the Terms Selection Module of AI+Expert'.

Providing AI contract terms selection module, can avoid the subjective recognition of juries and jurors, etc. who lack of independence and cross-professional, and may improve the authenticity. The eight essential clauses of the contract require complete and concise, increasing the multiple-choice clauses, and reducing the self-made clauses. The key terms are the parties, quality, liability for breach of contract, dispute resolution methods, etc., which are improve to increase special provisions such as reconciliation, mediation or arbitration, applicable legal norms, synchronized evidence of reappearance or notarization, expert divide-grade and divide-professional verification, approbation of AI calculation and expert verification, etc. The terms are drafting options by the AI, wherein the offer voluntarily selects, and the commitment party independently approbates to take effect.

1. Provide the AI Agreement Terms System for Reconciliation, Mediation or Arbitration.

The dispute resolution method is that the AI automatically chooses first reconciliation, post-mediation, re-arbitration, and excludes litigation. The parties can change the choice, and AI will display the risk prompt of reconciliation, mediation or arbitration, the parties can choose good performance, high comments, low fees; and can choose the avoidance clauses, to exclude interference from all interests and prejudice. AI automatically optimizes for selecting the lawyers, arbitrators and their institutions in the expert database.

2. Provide the AI Applicable Terms System for Selecting Legal Norms.

Applicable laws and regulations are that the AI automatically prompts relevant laws and administrative regulations of various countries. The parties may voluntarily choose partly based on judicial interpretation, departmental regulations, local laws, local regulations, etc., and AI will prompt the risk of normative conflicts. The parties may also voluntarily refer to some typical cases, business practices, national policies, local policies, etc., and AI will prompt the risk of normative conflicts.

3. Provide an AI Reappearance or Notarization Terms System for Synchronous Electronic Evidence.

The identification of synchronous electronic data-synchronization business evidence fact is that the AI automatically chooses to synchronously store relevant electronic data evidence and simultaneously deposit it with the agreed notary office. When dispute after the event, the AI reappears the incident and the key evidence from the electronic data, and the both parties approbate to take effect; when a party does not approbate, the AI provides online notarization, and takes effect after delivery.

4. Provides an AI Expert Terms System for Divide-Professional and Three-Grade Selection.

AI expert database sets up three-professional according to the evidence, fact and law of business; and evaluates three-grade as intermediate, advanced and super grade; it strictly assesses to promote, updates the promotion, and further realizes professionalization and practicalization. The experts are responsible for transparency and interpretation of AI algorithm; the charging coefficient is set at different levels, and the user chooses voluntarily and AI performs automatically. Details see I (III) 3.

5. Provide an Approbation Terms System for AI Calculation+Expert Verification.

For business evidence, facts, adjudications, both parties automatically choose AI to apply reinforcement learning of scientific logic and deep learning of human experience, make a most accurate and a most suitable evidence identification, fact identification and legal adjudication A and B. Both parties accept the plan in the interval to take effect. When one party does not approbate, applies for business experts in the interval and online video verification, and takes effect after delivery.

(II) Synchronizing Evidence Fact:

Provide the Identification Module of AI Reappearance+Notary+Reconciliation.

AI legal affairs provides online communication, audio-visual transmission, video communication and other social tools, and synchronously involves in the whole process and key links of business, and simultaneously stores related communication electronic data. Without dispute after the end of the transaction, most of them can be restored empty except for the relevant analysis data.

1. Provide Information System for Notary to Deposit AI Data.

Business AI data are the electronic data formed by AI in the process of business transactions. For important parts, such as high probability of disputes, large amount of transaction and special requirements of users, the AI legal affairs provide computer storage services. At the same time, it provides simultaneous online depository and preservation services to the office of the selected notary, to prepare for the future notarization.

2. Provide an Identification System for Both Parties to Approbate AI Reappearance Evidence.

When dispute after the event, the AI reappears all business facts and key business evidence relying on business transaction data in accordance with the contract, both parties approbate without objection and reaching a settlement agreement to take effect. Most parties believe that scientific progress, opposition to human intervention, voluntary approbation and reconciliation will be more and more, Both parties approbate the evidence fact, and facilitate reconciliation, mediation or so on.

3. Provide an Identification System for Social Notarization AI Data Facts.

When one party does not approbate the business evidence fact reappeared by the AI, the notary office conducts AI online notarization of the data evidence fact deposited in accordance with the agreement by the application, so to verify the authenticity and legality of the data. Only by approbating or notarizing the evidence fact of data, can promote voluntary reconciliation, and then facilitate first-mediation and post-arbitration. A phased approach facilitates a more realistic resolution of disputes.

(III) After-The-Fact Evidence Fact:

Provide the Verification Module for AI+Expert+Reconciliation.

It is difficult for AI legal affairs to reappear the really truth after the fact with business evidence and business facts without synchronous electronic data. The after-the-fact authentication of general business evidence causes many authenticity problems. The authentication of non-business experts and non-objective “free heart evidence” aggravates the crisis of authenticity and trust.

1. Provide an Identification System for AI+Mutual Approbation+Reconciliation.

After-the-fact business evidence and business facts identification is provided, wherein AI legal affair first applies reinforcement learning of business scientific logic and deep learning of human business experience, to make a most accurate and a most suitable identification A and B. Both parties approbate the interval and choose a settlement within the interval to produce legal effect. First the evidence is approbated, then the facts are approbated, which facilitates timely reconciliation, harmony and win-win.

2. Provide the Evidence Verification System for AI+Three-Grade Experts+Reconciliation.

Without one party approbating AI identification, the business evidence expert is selected firstly according to the contract, and makes the evidence verification conclusion within the interval with proving force. The party without approbation can apply for the higher-level verification, and can apply for three times and three-grade. The effect of the verification of the superior grade is higher than that of the inferior. Without objection to the verification of evidence, a settlement plan can be reached in time to resolve the dispute as soon as possible.

3. Provide the Fact Verification System for AI+Three-Grade Experts+Reconciliation.

After the evidence verification, the fact verification can be carried out. The business fact expert is divided into three grades, and both parties can apply for the three-grade verification in turn, or directly to the advanced grade or super grade. One party can apply for upgrade verification after the delivery is signed, and the effect of the verification of the superior grade is higher than the inferior, except both sides jointly approbating a certain verification. The fact verification is approbated by both parties, to facilitate timely reconciliation and resolve disputes as soon as possible.

(IV) Reconciliation, Mediation or Arbitration:

Provide the Adjudication Module for AI+Expert+Reconciliation+Mediation.

The quality of German judges is higher, the rule of law is more standardized, and there is very little human intervention. The criminal misjudgment rate is 1/4, the civil appeal change and return rate is more than 40%, that warn the judicial issue. Except for subjective determination of evidence fact, the key is that subjective adjudication lack objective constraints and supervisors are unwilling to correct the mistake.

1. Provide a Reconciliation System for AI+Both Parties Approbation.

The application of the law is provided, wherein the AI first applies reinforcement learning of scientific logic of the adjudication algorithm and deep learning of human experience of the classic case according to the contract, so as to make a most accurate and a most suitable adjudication A and B respectively. Most of the parties trust AI judgment prediction that they are willing to choose an acceptable solution within the interval, and both parties approbate without objection to take effect.

2. Provide the Mediation System of AI+Three-Grade Lawyers.

AI adjudication predicts without one party approbating, both parties may apply for three-grade mediation of intermediate, advanced or super grade lawyers step by step according to the contract, or directly apply for advanced and super grade. The effect of superior mediation is higher than that of the inferior; both parties voluntary reconciliation during mediation is a priority. The mediation lawyer chooses the reconciliation or mediation plan in the adjudication interval A to B, interprets the algorithm, and persuades the acceptance, wherein the delivery should be signed to take effect.

3. Provide the Adjudication System of AI+Three-Grade Arbitration+Mediation.

The arbitration experts conduct the online trial of the stereoscopic video, and try to close the case by means of reconciliation. With the mediation failing, the experts make the arbitration in time, selecting a judgment plan in the interval A to B, and explain why beyond the interval. Arbitration award shall be final and binding, the final decision takes effect after delivery. Both parties may apply for upgrading mediation or arbitration, before the delivery of intermediate or advanced arbitration is signed, or directly apply for advanced or super arbitration.

4. Provide the Online System for Acceptance Trial Delivery.

Online acceptance and filing system are provided to avoid local protection and human interference. The application, payment, exchange of evidence, and defense rebuttal are all conducted online. The case request, the fact reason, and the evidence content shall be subject to the concise summary language of both parties, and shall be strictly prohibited from abridging and concealment. The document is immediately sent online to prevent delays strictly. Avoidance and confidentiality applied from both parties are respected.

5. Providing Input and Output Systems for Stereoscopic Video Trials.

Each party can take 4 shots of input video, each arbitrator can take 2 shots of output video, and the lawyer is the same. The video can be combined in one or two screens for synchronization display. Synchronous recording and video are used since body language is richer and more real. Stereoscopic video input and output software can be authorized to produce AI hardware, light and portable, intelligent and multi-purpose. Detailed description is shown in FIG. 4 and embodiment 4.

(V) Quality Performance Guarantee:

Provide the Performance Module of AI Credit Rating+Insurance Guarantee.

The adjudication without executing, is just a piece of a waste paper, damaging social integrity, increasing transaction costs and reducing national competitiveness. Conventionally, some problems need to be solved in execution, such as too many mistakes in adjudication, too difficult to correct; some people corruption in execution, too high a draw; light penalties for overdue punishment, and rich profits .. .

1. Provide an AI Assessment System for Both Parties' Credit Status.

AI legal affairs applies reinforcement learning and deep learning systems, and makes a most accurate and a most suitable credit line identification for the assets credit level, quality assurance ability and performance compensation ability according to the user's identity documents, bank cards, credit cards, purchasing and selling pipelines, performance credit and other information. The employed third-level financial experts select an appropriate amount within the interval to prevent overdrafts.

2. Provide AI Quality Assurance System for Quality Insurance Guarantee.

When the user accepts without objection and confirms the payment, AI quality assurance system makes a payment within one week. When the user accepts without objection but unconfirms payment, the AI system indicates the quality objection every three days, and makes the payment within two weeks without objection. When the user proposes the quality responsibility without return goods before payment. AI system first choice is to return and refund. When the user rejects to return and the payment exceeds the credit line, opposing party shall provide quality insurance and guarantee.

3. Provide the AI Performance System of Indemnity Insurance Guarantee.

AI performance system combines the merchant's promise of several times compensation for quality responsibility, the same trade probability of causing personal and property losses, and the merchant's quality history and contingent compensation quota, to calculate the credit quota interval, and the three-grade financial experts select the credit line within the interval. For those who exceed the ability to compensate, insurance and guarantee are carried out to diversify the risk of performance. Prepaid prepayments can be used to pre-authorize merchant credit cards.

4. Provide the Actual Loss Compensation System of AI+Experts.

The actual loss of quality liability compensation must be calculated with the time value and the loss of excessive devaluation of the currency, and the actual loss of large data statistics should be taken as the criterion to exclude the improper provisions and explanations of the authorities to protect the breach of contract and benefit from it. Compensation is calculated by AI, selected by financial experts, timely online transfer, and prepaid within the credit line to ensure that the damaged party uses the money in time, and leaves room for it.

5. Provide Both Benefit Payment System of AI+Experts.

AI calculates time value and depreciation loss timely and accurately, transfers payment in time, changes the bad habit of delay in breach of contract, encourages timely payment in compliance with contract, and reduces the loss of breaching contract. The insurance will spread the risk, reduce the loss of both parties pay by the credit line to alleviate the financial pressure of damages. Both parties can benefit from AI and dual protection mode.

(VI) Legal Supervision Assistant:

Provide the Supervision Section of AI Case Calculation+Expert Verification.

It can be found that many misjudgments lack opportunities for correction from the high misjudgment rate and low appeal rate in the United States and Germany. Many false and wrong cases are difficult to correct from the system of plea bargaining and the system of limited appeal; in addition, the rule of man requires absolutely high accuracy index, legal supervision is rarely effective.

1. Provide the Contract System for Case Entrustment and Materials.

Firstly, both parties must voluntarily entrust and sign a contract, or have a unilateral entrustment that can provide the main evidence and factual material of both parties. Secondly, there should be the acquiescence of the local legal ecosystem, or no opposition to the positive role of AI in the judiciary. Thirdly, it required all closed case materials from the relevant organs, or all evidence and factual materials of cases provided by both parties.

2. Provide a Supplementary Verification System for AI Investigation and Verification.

Before the case is closed, AI further collects relevant on-site audio and video recordings and witness testimony through the Internet of human, Internet of things and Internet of intelligence. After the case closed, AI will check and verify through the Internet of human, Internet of things and Internet of intelligence, highlighting the evidence and facts in dispute.

3. Provide a Certification System for AI+Expert Verification.

Refer to the above-mentioned “AI+Legal Computer Procedures”, provide new evidence of party approval, AI calculation, and expert verification, which evidence, facts, and laws of civil, administrative, and criminal disputes that have not been identified or have been identified.

III. Provide Software or Hardware for AI+Legal Affairs+Business Affairs:

Provide the Body Frame to Control or Improve Business Affair Quality

In order to improve the quality of business affairs, on the basis of entrepreneurs group, employees group, users group and so on of Internet of human, it provides key identification of qualifications and credits. On the basis of the process control or improvement of Internet of Things, it provides the services of digital craftsman spirit, underlying cutting-edge technology and business quality improvement. With the flexible deployment of the super-brain of Internet of intelligence, it provides the application mode and application scenarios of intelligent goods services, featuring “two lines and two supports”.

(I) AI Goods Services:

Provides AI Operating Module for Subject Verification, Quality Verification or Nearby Stores.

For the E-commerce problems under the above “Background Technology”, AI technology is applied to provide subject identification, integrity evaluation, quality level identification, video selection. and provide AI systems for nearby stores, online and offline, homogeneous prices, and shopping experience, so as to solve the problems such as fake and inferior, disputes difficult to resolve.

1. Provide the AI Systems for Collaborative Development and Assisting the Small Weak.

It conducts divide-class and divide-grade for all operators, large and small enterprises, etc., to improve their strengths and complement their strengths. It focuses on certifying and promoting of qualification credit of fine enterprises. It provides the small and weak operators the opportunities to underground root and sprout, and constantly grow up; wherein it accommodates and assists small businesses that are difficult to survive and gradually weaken; it sets an excellent benchmark and guides small and weak enterprises to become bigger and stronger as soon as possible.

2. Provide the AI System for Quality Subject Identity Verification.

It provides the identity verification and evaluation ranking of quality subjects such as production provider, channel supplier and seller. It provides verification evaluation of growers and geographical locations of food and medicine, It provides channel price audit, insurance or guarantee for performance, etc. Consumers can have online positioning, video calls, mutual recognition, and comparative choices, so as to increase the responsibility of honesty, and reduce people's leaving with empty buildings.

3. Provide the AI Systems for Comprehensive Optimization and Assisting the Low Prices.

It conducts divide-class and divide-grade for all commodities and services, and meet the needs of multiple levels. It focuses on controlling the quality and process of fine business affairs. It provides the low-cost commodities services of underground survival opportunities to make the best use of them and to voluntarily trade; wherein it will be inclusive and facultative to low-priced goods, second-hand goods, flea market, underground market; and it sets up high-quality business affairs and guide low-price business to remould and promote.

4. Provide an AI System for Service Quality Verification.

It provides quality verification for qualified, excellent, leading service; in particular, the service provider's qualification credit, industry history ranking, service process features, etc., and the server's qualification credit, resumes and specialties, etc. it provides service quality classification, strict high quality and high price and so on; wherein it indicates the risks and responsibilities for defects, below cost, and no quality assurance services.

5. Provide AI System for Business Quality Verification.

It provides verification for composition and quality of qualified products, first-class products, and luxury goods; especially food and drug environment soil, production process and so on. It provides quality classification, high quality and high price, channel guarantee, etc.; especially quality insurance or guarantee. It indicates the risks and responsibilities for defects, below cost, and no quality assurance services.

6. Provide AI System for Near Store, Online and Offline.

The online extends to the bulk and small, providing intelligent search, quality classification, integrity sorting and other options to exclude irrelevant advertisements. It provides video communication links, video identification and selection purchase, to exclude the interference of meitu and jigsaw. The offline stores provide location search, nearby stores online shopping, online and offline homogeneous price, and express pick-up optional; wherein the “two lines” complementary advantages and complement each other.

7. Provide AI System for Sightseeing Training and Experience Promotion.

For excellent service and commodities, and for the ingredients, technology, production or processing, sightseeing tourism routes, and practical operation experience are provided., and teenagers' training base, and practice base are also provided. It encourages users to experience on-site, select and buy now, improve shopping's pleasure and satisfaction, and guarantee the quality of goods and services.

8. Provide AI Systems for Integrating Internal and External, Value-Added Innovation.

The AI systems provide AI targeted selection services such as social-intercourse, information, video, live-broadcast, entertainment, games, payment, study, travel, new-retail, life-services, linking legal or business featured services; Integrate international, domestic, self-operated, other-operated, e-commerce, store businesses, goods, services; Prominent the innovation of the legal mode; light assets, heavy talents, heavy mechanisms; revenue priority to commission, promotion, value-added.

(II) AI Health Care:

Provides AI Operating Module for Index Analysis, Difficult Consultation or Expert Entry.

The quality problems of medical services under “Background Technology”, are mainly about medical technology and uneven distribution. It applies AI technology and provides health index analysis and prompt information, disease diagnosis and treatment advice, difficult consultation and medical treatment programs, and solves the problems of treating the poor and settling disputes.

1. Provide the AI System for Health Indicator Analysis and Prompt Information.

AI health applying the analysis technology of gene sequence and physical examination index, inputs the gene sequence and physical examination index according to the online treaties, provides information such as health index comparison, dietary guidelines and food connection, displaying on the mobile phone or watch ring, and provides online video identification of food and drug quality. The watch ring can also be used as a physical examination sensor and data input.

2. Provide AI System for General Disease Diagnosis and Treatment Recommendations.

AI medical care provides advice on the diagnosis and treatment of general diseases, applies deep learning the human experience of classic cases, reinforcement learning the scientific logic of the medical monographs, inputs the daily health, and genetic information according to the online treaties, and then input specific examination images and report data, and displays on the mobile phone or watch ring. The prescription can be applied for expert video diagnosis and signature confirmation.

3. Provide the AI System for Difficult Disease Consultation and Medical Program.

AI medical care provides different medical program intervals A and B, applying deep learning and reinforcement learning according to the online contract. It provides a global therapeutic expert database for difficult diseases, according to the middle, advanced and super divide-grade for patients to choose. Online stereoscopic video diagnosis provides consultation medical plans in AI interval, which needs to be explained outside AI interval. The difficult disease experts diagnose through on-line stereoscopic video, provides consultation medical scheme in AI interval, and needs explaining outside AI interval.

4. Provide the AI Family Hospital System for Doctors and Nurses Door-to-Door.

For general and difficult diseases, doctors and nurses can make an appointment to provide treatment, surgery, and nursing services. For intractable diseases and surgery, the expert team may be invited to provide online video guidance and share the resources of the world medical elite. Portable equipment can be used and sanitary sites facilities can be rented near counties and villages. Especially in the spare time and holidays, a large number of idle expert resources can be used.

5. Provide the AI Community Hospital System for Specialists Doctors Entering Villages.

Township hospitals, village health centers, community health stations, and even county hospitals can provide medical examination services to patients with AI. The patient's health indicators, photograph, and examination report are input into the health data of the patients. Rural village doctors can prescribe treatment for patients based on AI health information and treatment recommendations. Suspected diseases can request experts assisting for online consultation.

6. Provide AI Video Virtual System for Global Medical Experts.

The AI video virtual systems provide patients with health data and images, and explain abnormal indicators. Provide video and virtual organs for complicated diseases. Provide virtual expert consultation and surgical guidance for the diagnosis and operation of complicated diseases.

(III) AI Education Training:

Provide AI Operating Module for Education Enhancement, Featured Training or Talent Cultivation.

The quality problems of education service under “background technology” above are mainly uneven quality resources and lack of effective talent cultivation mechanism. It applies AI technology, and provides education improvement, skills training, special training, talent training, etc. to solve problems such as poor people lack of education and difficulty in solving disputes.

1. Provide AI Online Teaching Video System for Education Upgraded to Master Degree.

Applying speech recognition, video recognition and other technology, and deep-learning human teaching experience, provides teaching videos of human experience version. Applying reinforcement-learning the scientific logic in various disciplines and specialties, refines and organizes the whole knowledge of each discipline and specialty, and provides the teaching video of scientific logic edition. It also provides AI ranking and connection for similar teaching videos at the same time.

2. Provide AI Online Training Video System for Skills Qualification Examinations.

The AI applies deep-learning and reinforcement-learning: studies postgraduate exams, overseas exams, English exams, practicing qualification exams, professional title exams, life and occupation high-end technical examination and basic skills teaching video and provides training videos of human experience version and training videos of scientific logic version. It also provides AI rankings and connections for similar training videos.

3. Provide AI Online Feature Video System With Personalized Education Training.

The AI applies personal genetic inheritance health data, EQ and IQ test data, educates according to individual ability, adds life and work skills, to the subjects of primary, middle school, bachelor master's courses, compresses it to 5, 5, 5 years, and provides AI online video system of features education training, such as personalized education upgrades, postgraduates, practicing qualification, professional title, knowledge skills, and going abroad.

4. Providing AI Feature Cultivation Schools for the Generalists And Versatile, Innovative Talents.

Applying AI gene inheritance, IQ and EQ analysis makes full use of the holidays, enlightening various interests and potential hobbies in kindergarten for 3-2 years, experiencing local life style and humanities in primary school for 5-4 years, comprehending the production and operation skills of workers, peasants, soldiers, students, businessmen and other trades in middle school for 5-4 years, and guiding the direction of professional interest in bachelor and master's university for 6-5 years. Three semesters are in one year, wherein the AI fine simplifies course, only really not famous, and it proves the test of the sea score tactics and provides an excellent graduate student to parents and society before the age of 20.

5. Providing AI International Cultivation System for Innovation Elites.

In primary schools introduce life skills education, provide taking turns to teach in classes around the world to understand the differences of language and cultural. In secondary school introduce work skills education, provide taking turns internships in various industries to understand the rules of various trades in holidays. Apply AI video, AI exercises to review after class, use three-semester per year compression system, and cultivate innovative elite talents as early as possible.

(IV) AI Traffic Transportation:

Provide AI Operating Module for Predictive Sensing, Position Video or Three-Dimensional Traffic.

The quality of transportation services under “Background Technology” above is mainly due to insufficient time and space and traffic congestion in large cities. By applying AI technology and providing the sky-eye navigation, it selects opportunity to travel and store, and sensory navigation helps the car to be unmanned. Three-dimensional traffic can expand the accommodation space.

1. Provide the Sky-Eye System for the Time-Space Distribution of the Recent Traffic Flow.

Macroscopically, by applying the monitoring data of vehicle flow and stocks in the past week, it predicts the time and space distribution of travel and storage in the next week is in advance, then provides the sky-eye navigation forecast maps with different time and space in seven days. It real-time monitors the time and space distribution of travel and storage on the same day, and provides the actual observation maps of the sky-eye navigation in different time and space of the day, for searching for gaps, navigation trip and inventory.

2. Provide the Sensing System for the Environment Surrounding the Road at the Time of the Vehicle.

On the micro level, by applying the technology of driverless vehicle and the vehicle-on-vehicle sensing system to provide the sensing video, and adding the forecasting and measuring maps of the sky-eye navigation, it forms the sky-eye navigation map and the sensing video of the manual driving, for searching for the gap and navigating trip and inventory. When tired and sleepy, it applies the on-board sensor to sense the surrounding environment, automatically plans the driving route and controls the vehicle.

3. Provide the System for Line Location and Handover Video.

By applying AI's timing positioning technology, video recording technology for business handover, it provides AI logistics control or improvement system. In the logistics channel of goods, it does well logistics process control, real-time monitoring; preventing the leopard cat to change the prince, change the package, and fake truth. It supports the subject of responsibility verification, insurance guarantee, strengthen quality responsibility at the same time, and reassures consumers.

4. Provide the Three-Dimensional Traffic System to Increase the Space of Cars.

(1) Provide the “Three-Dimensional Traffic” Layered System.

In the congested areas of large cities, it builds more than six floors of roads and parking spaces with functional stratification, so as to increase the area, save the cost of subway construction and the cost of damage to the stratum structure. It can also combine municipal engineering with private shopping malls, Municipal public transportation can be built below the fourth floors, and private shopping malls can be built above the third floors. for example: The first floor: a free layer for pedestrians or heavy vehicles (aerial trains can be added above); The second-third floor: a bus layer for subways, trams or buses transports(parking lots can be added); The fourth-sixth floor: a self driving layer for rentals, cars or public buses (ditto); The seventh floor: a shopping consumption layer (ditto); The eighth floor: a sightseeing leisure layer (cable cars can be added above); see FIG. 5 for details.

(2) Provide the “Three-Dimensional Traffic” Hub System.

At the intersections and hubs, green belts, upper and lower elevators and pedestrian passages will be equipped along roadsides, which can be connected to shopping malls and connecting fueling interfaces, saving construction costs and bypass costs of flyovers and underground passages, and saving urban land and beautifying urban space.

(3) Provide the “Three-Dimensional Traffic” Parking Space System.

Each floor can be built with 2-3 layer three-dimensional parking spaces. AI robots can allocate and sort the parking spaces according to time in and out of storage, and existing space, carrying cars into and out of the storage.

(4) Provide the “Three-Dimensional Traffic” Navigation System.

In the three-dimensional traffic system, vehicles with different weight tonnages can be driven in different layers to avoid heavy traffic accidents caused by mixed traffic; using AI sky-eye navigation map+sensor video, stereoscopic navigation vehicle travel and parking, improves the efficiency of travel and storage.

5. Provides the Three-Dimensional Transportation System for the Waterwheel-Type Multi-Car Elevator.

(1) Provide the Structural System for the Elevator of a Car Residential Building.

(i) stratification-added parking spaces: 2-3 simple three-dimensional parking space are built between stratification road. (ii) automobile residential building: several high-rise “automobile residential buildings” with elevators can be designed and built on the side of stratification roads according to different tonnages as a whole. (iii) Car robot, AI control, compact and flexible, allocates parking spaces according to time and space, ranking and carrying into or out of the garage; and cooperate with elevator to transport vehicles up and down or turn around. (iv) Elevator structure, It is mainly divided into four space: machine room, well and pit, car, layer station; and eight systems: traction, guidance, car, door, weight balance, electric drive, electrical control, safety protection.

(2) Provide the Waterwheel-Type Elevator Improvement System.

(i) Four corners of the car, 0.1-0.8 meters front and rear, and 1 to 3 meters above, use four drawing wire ropes to share the parallel pulling force; (ii) Annular wire rope, four parallel right-angle steering and traction force systems are set at the upper and lower ends of left, right, before and after; and fixed position and anti-falling lock system are set at the force awarding place of each layer; (iii) Six sides of the car, with passenger closure priority, with cargo semi-closed priority, the spacing between semi-closure and the well should be controlled within 0.1 m; (iv) Direction of entry and exit: left and right separation for passenger, the passenger moves clockwise, and the cargo robot can help to move forward and backward, left and right; (v) Number of hanging boxes: according to the time and space distribution of flow, the maximum number of hanging boxes for customers is one per floor, and the maximum number of hanging boxes for cars is two or three per floor;

(3) Provide AI Elevator Improvement System.

(i) Safety identification: The resident owner of a certain floor, shall reserve basic information such as identity, number and mobile phone, and reserve identification information such as fingerprints, audio and video, AI verify to release; (ii) Guests appointment: a temporary visitor on a certain floor, register information such as identity, number, audio and video, then swipe the ID card and pay the deposit electronically, AI identify to release; (iii) AI in and out: with inbound and outbound communication information system, AI timely calculated, coordinated, and quick arrange and assist; the owner master timing, fixed point in and out, shall book and pay in advance three or five minutes; (iv) Quota budget: the owner's quota are determined based on frequency and rate, pay at a discount when paying the property fee, the original payment will be returned after the host pays the guest; (v) Man-machine guarantee: not only set up the power guarantee system, but also prepare the generator to deal with power outages, besides, can shut down the AI system, start the configured mechanical power, and manually control the system.

AI legal affairs can quickly solve relevant traffic disputes as shown in (I)-(V), especially the sky-eye navigation map and sensor video, and Zibo arbitration of traffic disputes experience.

(V) AI Business Expansion:

Provide AI Operating Module for Open Competing, Self-Improving, Merging or Restructuring.

The development of science and technology is accelerating, and the development and application of AI is changing with each passing day. The battlefield of AI business will be a hurricane in the red sea of blood and rain; AI business has its birth and death, prosperity and decline. So it is necessary to make ready to advance and retreat, defend and abandon, and cooperate and score. AI applies reinforcement learning and deep learning, AI can predict the growth cycle of AI business enterprises according to the operating data of market, industry and enterprise, merger and acquisitions choose the leading technology companies,

1. Provide Business Expansion With AI Business Mode.

This mode is mainly applicable to the business field where the computer AI program has advantages. The emphasis is on the field where the double-learning of reinforcement-learning and deep-learning is, and the double-experts of expert system and expert database of divide-grade and divide-professional can play an advantage in the field, especially those with the nature of public service and social governance. For low-price business needs, underground economy, also need to intervene and guide development.

2. Provide Business Expansion With AI+Legal Business Mode.

This mode is mainly applicable to the business field with advantages of AI legal services. The emphasis is the field where the new brain and new procedures can play advantage, that is, excellent business subjects and high-quality goods services, which belong to the key areas of AI legal services, especially public services and social governance; for low-price business needs, and underground economy, it is also needs to step in and guide the promotion.

3. Provide AI Operation System for Business Peers to Mutual Assist and Open Compete.

To make AI industry bigger and stronger, with a dense forest, the AI+legal affairs+business affairs has the living environment and space. Dedicating to the “industry to develop and grow, peers to compete and help each other” rules, it provides an open AI competition platform, a hundred schools of contention, a hundred miles of competition, the introduction of industry pioneers, learning and learning to improve; and it provides the competition platform and profit opportunity for AT business peers.

4. Provide AI Operation System With Business Leaders in the Same Platform to Self-Improve.

To survive and develop in AI industry, practices internal skills first, makes profits and has cash flow, then harmonious symbioses with partners and benefits everyone's common development, again represents the peer direction, as the leader. Therefore, to retain own advantages of AI characteristics, learns and improves constantly, maintains own competitive advantage, without stuck by opponents; it rewards AI good advice, and golden ideas. 5. Provide AI Operation System for Business Support and Rescue, Merge and Reorganize.

There must be life and death in the fight and killed battlefield, and there must be survival and death in the business competition sea; for the defeat of the competitors, it should “rescue the dangers, you me together”. Therefore, it provides AI to predict the growth cycle of business enterprises, merges and reorganizes the leading technology and dying companies in the same industry, merges and reorganizes the backward sectors in its own business to maintain the prosperity of the industry and improve its vitality.

### BRIEF DESCRIPTION OF THE DRAWINGS

In order to more clearly illustrate technical solutions of the embodiments or the current technology, the following is a brief introduction to the drawings that need to be used in the embodiments or in the existing technical description. Obviously, the drawings in the following description are merely embodiments of the present invention. For the ordinary technicians in this field, other drawings can be obtained according to these attached drawings without any creative labor.

FIG. 1 is a flowchart of reinforcement learning and deep learning algorithm+expert verification

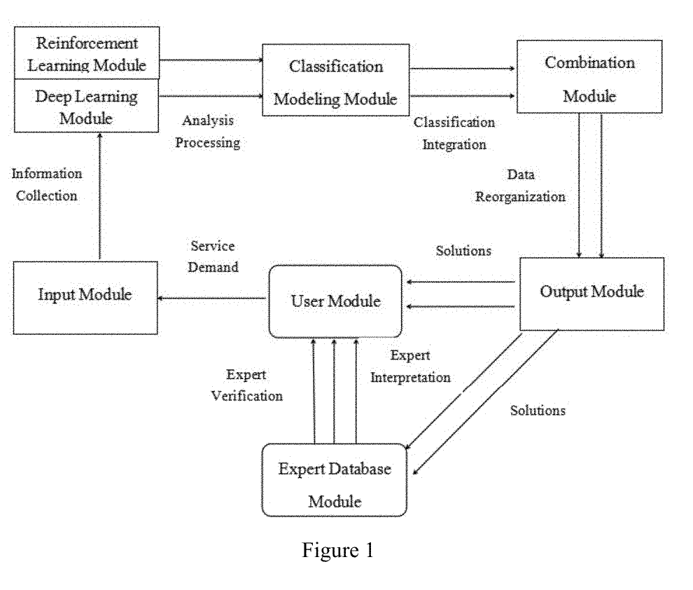

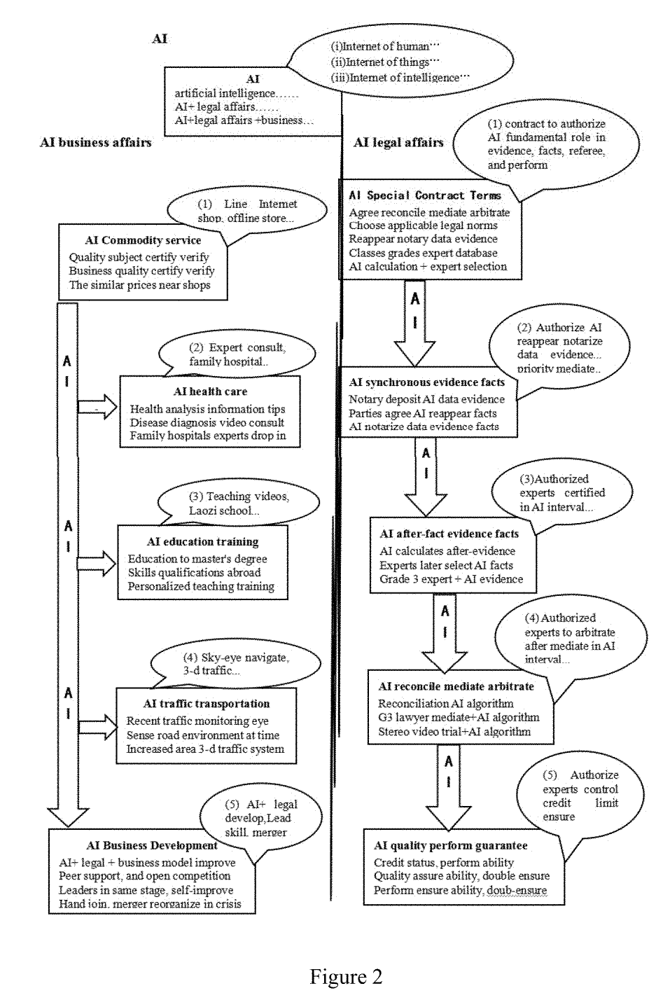

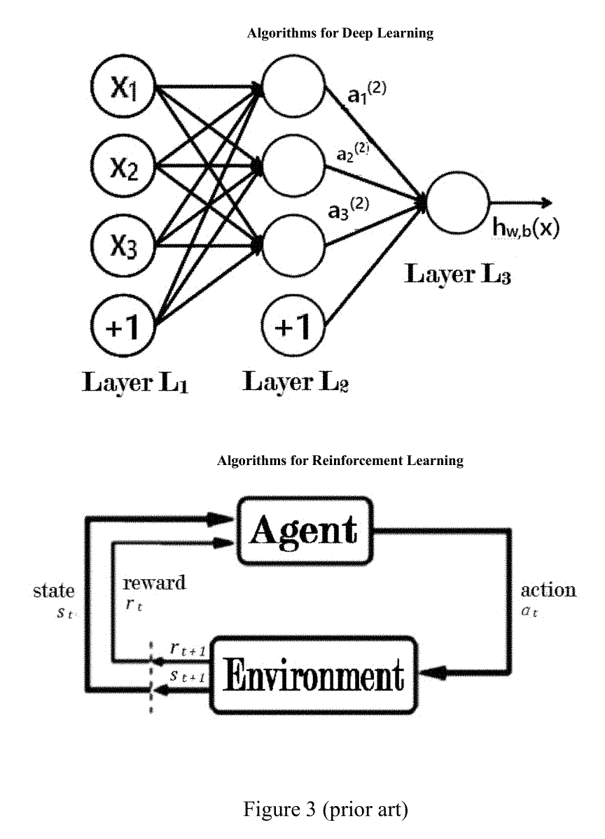

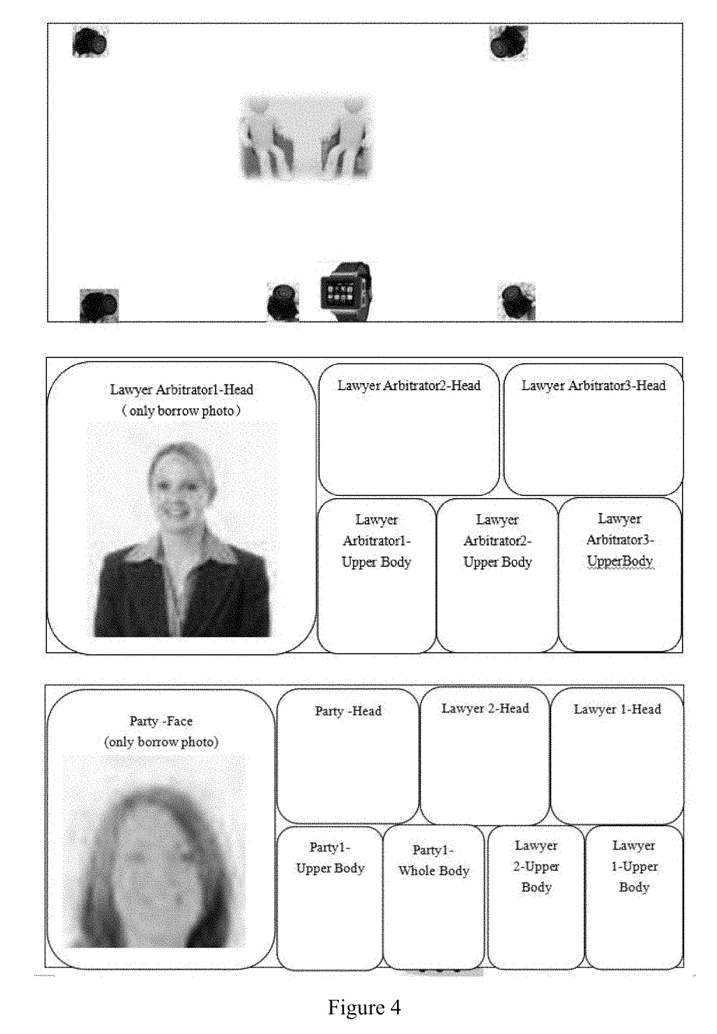

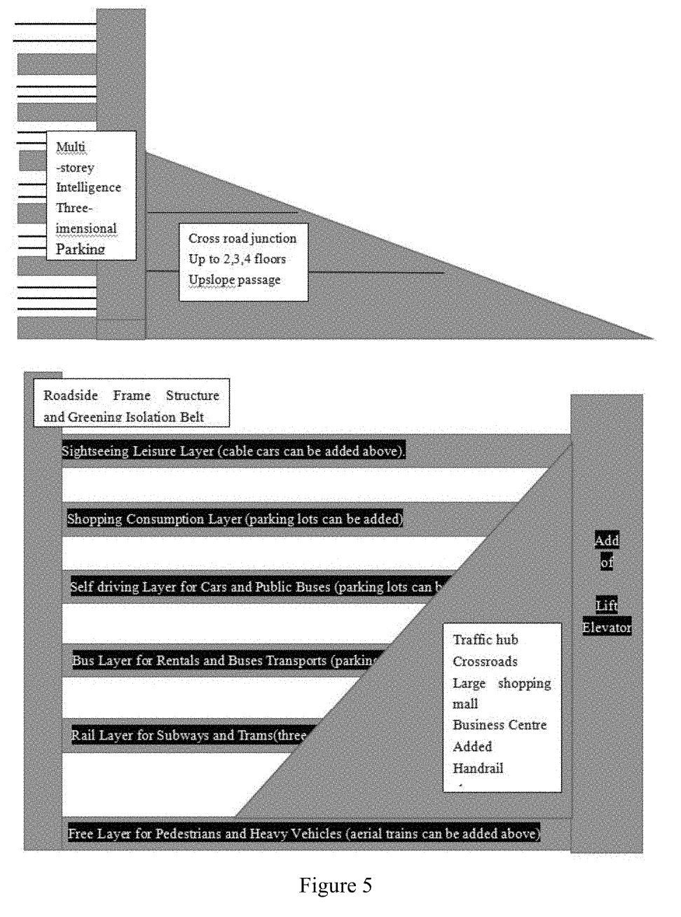

For after-the-fact evidence fact on legal affairs, AI provides a most accurate and a most suitable identification based on reinforcement learning and deep learning, for the parties to select or for the experts of business evidence fact to select verify at divide-professional and three-grade. For the application and adjudication of law on legal affairs, AI provides a most accurate and a most suitable adjudication based on reinforcement learning and deep learning, for the parties to select or for the legal experts to select verify at three-grade.

For the qualification credit and credit limit of fine business subjects, AI provides a most accurate and a most suitable identification based on reinforcement learning and deep learning, for the parties to select or for the experts to select verify at three-grade. For the high business quality, process control, AI provides a most accurate and a most suitable identification based on reinforcement learning and deep learning, for the parties to select or for the experts to select verify at three-grade.

FIG. 2 is a relation diagram of process control or improving for AI+legal affairs+business affairs

The main application of AI lies in: on Internet of human, set up the expert database to identify the credit qualifications of business subjects; on Internet of Things, identify business affairs quality, to control or improve the production and service processes; on Internet of intelligence, to coordinate and to complement reinforcement learning, deep learning, expert systems and experts database.

The main application of AI+legal affairs lies in: applying reinforcement learning, deep learning, expert systems, expert database, makes up for the shortcomings of human intelligence. Applying AI, controls and improves legal procedures, such as contract freedom, evidence identification, factual identification, legal application, reconciliation, mediation, arbitration, and automatic performance. The integrating AI legal services into specific business processes, provides a legal protection framework for business.

The main application of the AI+legal affairs+business affairs lies in: based on Improving Internet of human, Internet of Things, Internet of intelligence, innovates the new process of the AI legal services, integrate into the business field that needs to take advantage of the AI+legal affairs advantages, The emphasis is on excellent enterprises, high-quality goods services, especially in the field with public services nature and requiring social governance, such as education, medical care, transportation, etc., For the low-priced goods and underground economy, guide to become bigger and stronger, thoroughly remould and reborn,

FIG. 3 illustrates comparison of algorithms for reinforcement learning and deep learning

Reinforcement learning, also known as reinforcement learning and evaluation learning, is the learning of the agent from the environment to the behavior mapping, so that the reward signal (reinforcement signal) function value is the largest; the learning is done in a “trial and error” manner, the goal is obtain the biggest reward; because there is very little information given by the outside, it must rely on your own experience to learn by itself. The three most critical factors for reinforcement learning are state, behavior, and environmental rewards.

The difference between reinforcement learning and deep learning is that Google's AlphaGo Zero (by playing chess with itself) defeats AlphaGo (training about 30 million sets of human chess data), that is, AlphaGo Zero not only abandons humans Chess score, learning from scratch, and abandoning the characteristics of human design, the abandonment of human beings thoroughly, in addition to the rules of the game, do not use any data and knowledge of humans.

Deep learning is also called deep structure learning, deep machine learning and hierarchical learning. It can be divided into supervised learning and unsupervised learning. It is a method of representation learning based on data in machine learning. The idea of deep learning is to stack multiple layers and express the input information in a hierarchical way. A special attribute of the flow graph is depth: the length of the longest path from one input to one output.

FIG. 4 is a schematic diagram of stereoscopic video online and dynamic adjustment The input video of each party consists of six Bluetooth remote sensing lenses with front and back two sides and far and near front, the four videos are taken with the most frequent changes of body movements such as the front side body, front other sides upper body, front head and front detail movements. The output video is taken from three remote arbitrators with frontal sides and close front, two picture per person, the same for the lawyer. According to the number of actions, the size is dynamically sorted, and the combination is synchronized display on the one or two screens.

The stereoscopic video input software can authorize the production of three cameras for stereoscopic input, which can be extended to online video projects such as online video consultation; stereoscopic video output software can be directly displayed on mobile phones, computers or mobile phone rings, and the watch ring can be extended to health care. Display reminders, measurement inputs. The stereoscopic video input software, can authorize the production of stereoscopic input six cameras, can be expanded to online video projects such as online video consultation. The stereoscopic video output software, can be directly displayed on the phone, computer or watch ring, watch ring can be extended to health care display reminder, measurement input.

FIG. 5 is a schematic diagram of AI three-dimensional traffic system layering, garage, navigation

Municipal public transportation can be built below the fourth floors, and private shopping malls can be built above the third floors. for example: The first floor: a free layer for pedestrians or heavy vehicles (aerial trains can be added above); The second-third floor: a bus layer for subways, trams or buses transports(parking lots can be added); The fourth-sixth floor: a self driving layer for rentals, cars or public buses (ditto); The seventh floor: a shopping consumption layer (ditto); The eighth floor: a sightseeing leisure layer (cable cars can be added above)

At the roadsides of intersections and hubs, green belts, upper and lower elevators and pedestrian passages will be equipped, can be connected to shopping malls and connecting fueling interfaces. Each floor can be built with 3-4 plus-layer three-dimensional parking spaces. Each floor can be built with 3-4 plus-layer three-dimensional parking spaces. AI robots can allocate the parking spaces according to the time and space, carrying cars into and out of the storage.

### DETAILED DESCRIPTION OF THE PREFERRED EMBODIMENT

in order to clarify the purposes, technical schemes and advantages of the present invention, a clear and complete description of the technical schemes in the embodiments of the present invention is given below. Obviously, the embodiments described are only part of the embodiments of the present invention, not all of them. Based on the embodiments of the present invention, all other embodiments acquired by a person of ordinary skill in the art without performing creative work shall fall within the scope of protection of the present invention.

### Embodiment 1

### Operation Scheme of Reconciliation, Mediation or Arbitration of the AI+Legal Affairs

Simultaneous data evidence fact, AI deposit and recurrence are provided, wherein both parties approbate voluntarily, reaching a settlement agreement; notarization certification is provided, guiding both parties to reconciliation, preventing most disputes. For the evidence, facts, legal data, video data of both parties to the dispute, AI applies reinforcement learning and deep learning to reach a most accurate and a most suitable identification and adjudication to it; both parties approbate voluntarily, and immediately reconcile; the evidence fact experts explain to persuade and verify, guide the both parties to approbate, and reconcile as the priority

Lawyers mediate and reconcile as the priority; if reconciling fails, the mediation book is valid for delivery and signing. Arbitrator arbitrates, once again explains to persuade, guides both parties to approbate, and reconciles as the priority; if reconciling fails, it should strive for mediation, and mediation book is valid for delivery and sinning; if mediation fails, timely arbitration is provided, which is valid for delivery.

### Embodiment 2

### Operation Scheme of User Contract Perform of the AI+Legal Affairs+Business Affairs

The transaction between the excellent enterprise and the high-quality business can be optimized by the IA system; AI provides the credit qualification information of the excellent enterprise and the quality identification information of the high-quality business. It is through the AI system to exchange, negotiate, sign contracts, choose the arbitration contract terms to give AI and experts the verification role; wherein both sides reach a cooperation intention, and can provide comprehensive dynamic due diligence according to the contract, to help both parties make timely and correct decisions.

Contract is performed, and the AI traces and controls the credit line of both parties, production service process, quality of goods services, and insufficient amount of insurance to provide insurance guarantees, prevent disputes, and perform delivery; Then the AI supervise to accept to confirm to pay; For quality problems, the AI urges objections, control quota. During disputes, the AI mostly reappears the facts of evidence, promote both parties reconcile; for after-fact evidence fact, AI legal procedures are applied to solve; for final implement, AI timely transfer quota.

### Embodiment 3

### The Operation Scheme of the AI's Talent Mechanism Capital

Heavy talent. It needs introduction, heavy use, and incentive mechanisms. It requires high-paying talents, recruiting part-time employment, and equity incentive technology management elite teams.

Heavy mechanism, It needs good law, good governance, needs to build a good and simple legal system, and an effective and active operating mechanism in the game,

Light assets. All countries are in excess of money, and the wealthy in China have more money and less good projects, but it need light assets to reduce risks and improve efficiency.

Light bondage, The development of AI is too fast, the decision-making process of state-owned shareholders is too slow, and it is not suitable for the needs of the technology market. It is necessary to introduce a private mechanism to operate flexibly.

American economist Mankiw believes that the competition for the comprehensive strength of the economy depends on talents and mechanisms; 15% of the technology or 5% of the revenue should be paid.

### Embodiment 4

### Operation Scheme of AI's Online Stereoscopic Video

Input video: In each party, the front and rear sides are about 45° angle, the front and the far angle are about 90°, wherein the six Bluetooth remote sensing lens are installed. AI automatically takes the most frequent changes movement of left or right body, right or left upper body, front head, front details, four together on a screen. Among them, the more action, the larger area occupies in the video, and the automatic arrangement of the size, from the average of four to one occupies the majority.

Output video: three remote arbitrators are taken with a 45° angle in front and a 90° angle in front, wherein two Bluetooth remote sensing lenses are installed. The AI automatically takes two pieces of the front upper body and the front head, counting 6 pictures. The lawyer is the same, plus the party's 8 picture, merges them into one or two screens to display synchronously.

The above input and output video can be synchronized and recorded as evidence. It can be stored as evidence and can be called at any time with the consent, but it must be kept secret.

As a video online consultation, the input Bluetooth remote sensing lens should be adjusted and aligned as needed, aligning lesions, such as the middle height of the operation.

The input video information of large-amount and complex controversies can be synchronously converted into a “virtual studio” of mediation arbitration by virtual reality technology to simulate the real situation. For evidence, facts, lesions, surgery and so on, virtual reality technology can be used for simultaneous conversion to simulate the real situation.

The stereoscopic video input software can authorize to product six cameras and load into AI system; the stereoscopic video output software can be directly displayed on the phone, computer or watch ring; the watch ring can be extended to the health medical display reminder and measurement input.

It can cooperate to develop virtual reality software and equipment.

### Embodiment 5

### Operation Scheme of Mobile Client of AI Goods Services

The page of the phone user terminal is divided into the top margin (search directory column), the bottom margin (main directory column), the left margin (detailed directory column), and the edition center (from top to bottom can be divided into: 1. business advertising, 2. life leisure, 3. hobbies, 4. related recommendations, 5. quick navigation and other columns), the solutions are as follows:

I. the “Homepage” solutions: mainly based on life, service, leisure and entertainment.

(I) Search directory column: in the search box, input voice, photo and video may be searched. intelligently.

1. Add to the left and right sides of the box: in the “Sweep” and “Information” columns, may add new columns: “Location” and “Member” (display authentication information).

2. Add new columns above the box: business, legal affairs, education, health, transportation and so on.

3. Add new columns below the box: video, pictures, information, games, entertainment and so on.

First click the upper and lower columns, then click the left end of the box, and then click the sub-column of the new column; enter the key content, then click on the search.

(II) Main directory column: in the “Home page” and “My” columns, add new columns “Shopping”, “Service” and “Legal”, as detailed in II˜IV the current embodiment.

(III) The column of the edition center for the dynamic display:

1. Business advertisement: set the picture scrolling left and right, and set the under point to display the left and right positions. According to the customer's educational background, curriculum vitae, interests, hobbies, habits and other characteristics, provide targeted and exciting information.

2. Living leisure: according to popular hobbies, increasingly provide such as hot topics, headlines, recommendations, social, live broadcast for easy selection.

3. Interest and hobby: according to user preferences, provide with high-click, self-selected columns, for convenience to quick.

4. Relevant recommendation: set the audio and video scrolling up and down, and the right scroll bar will display the up and down positions, and provide targeted and credible content according to customers' consumption ability and tendency.

5. Quick navigation: provide downward a related classified connection for general browsers.

6. Scroll down: provide relevant classified links to life services, leisure and entertainment, merchandise services, and legal behavior.

II. The “Shopping” page solutions: mainly based on E-commerce, store. The framework is like “Homepage”, and the relevance and pertinence are different as follows:

(I) 2. Add new columns above the box: such as high-quality, ensure-quality, voluntary, conversation, contract, etc.

(I) 3. Add new columns below the box: such as self-operated, E-commerce, store, large-amount, international.

(III) 2. E-commerce and store: According to the public's concern, increasingly provide such as B2C, self-operated, other-operated, new retail, payment, credit for easy selection.

1. “E-commerce”: dynamically rank other-operated and self-operated E-commerce companies according to their reputation and efficiency;

1. 1. “Self-operated” E-commerce: set the classification column on the left side, scrolling up and down, click into a certain category to select, and optimize constantly;

1. 1. 1. “Voluntary” E-commerce: second-hand, low-cost, imitation, underground economy (automatically warning risk voluntary);

1. 1. 2. “high-quality” E-commerce: luxury, well-known, famous, superior, first-class, qualified (certificate identification, quality verification);

1. 1. 2. 1. “ Ensure-quality ” E-commerce: quality assurance, indemnity insurance, production, channels, sales, positioning (identity verification of producers and sellers, performance guarantee, positioning verification of products, quality insurance);

2. “Store”: rank dynamically according to distance and reputation, and click on links such as nearby and connecting lines;

2. 1. “Connected” store: click emerging the phone number of the store far and near, and then click to selecting on video (E-commerce can also be connected);

2. 2. “Nearby” store: click emerging the location of the store (click to navigate), and related goods (click to select);

3. “Large-amount”: click on optional AI “contract” terms for conciliation, mediation, arbitration, to automatically save “conversation” records;

3. 1. “International”: click on the same as above, click on “Contract” and “Conversation” also shows “large-amount” and “international” links;

III. The “business service” page solutions: mainly based on business service. The framework is like “Homepage”, and the relevance and pertinence are different as follows:

(I) 2. Add new columns upper the box: such as high-quality, ensure-quality, voluntary, conversation, contract.

(I) 3. Add new columns below the box: such as business, life, education, health, transportation.

(III) 2. Business services: according to the public's concern, provide such as education, training, health, medical care, transportation, travel, life for easy selection.

IV. The “Legal affairs” page solutions: mainly based on legal affairs, contract. The framework is like “Homepage”, and the relevance and pertinence are different as follows:

(I) 2. Add new columns above the box: such as experts, notaries, lawyers, explanations, mediation.

(I) 3. Add new columns below the box: such as evidence, facts, laws, adjudication, execution.

(III) 2. Business services: according to the public's concern, provide such as evidence, notarization, lawyers, reconciliation, mediation, adjudication, execution for easy selection.

IV. Self-operated Shopping Cart, Settlement, Acceptance:

1. “Add to shopping cart”: click on the selected goods and services, scroll display quantity, quality, origin, manufacturer, seller, insurance, guarantee, etc., may click to select; “confirm”: click into the shopping cart, can be compared to modify, decide to buy

2. “Settlement”: click on displaying agreement on reconciliation, mediation, arbitration, selecting the applicable laws and regulations, authorizing the expert to verify the AI evidence facts, etc., may select or explain; “Submit order”: click -to-pay, the seller can confirm the validation, can also refuse.

3. After receiving the goods and services, the consumer will check and accept; after no objection to the quality, click to confirm the receipt and payment. If refuse to accept, return immediately; if after acceptance, no objection, no return, but did not click to confirm receipt and payment, AI reminds acceptance, objection every three days, 15 days later automatically confirm payment, and store data evidence of large transactions.

VI. AI Arbitration Terms for Business Other-Operated:

For the connection of this client, the large-amount or international business other-operated,

It can be agreed in the “Remarks” and “Messages” boxes other-operated: “Special Arbitration Terms: selecting the ‘Legal Intelligence credit business’ mode in the XXX International Arbitration Institutions and Rules”, then the AI stores the conversation data.

What is claimed is:

1. A business operation mode of artificial intelligence+legal affairs+business affairs,
which is a kind of solution by executing AI computer program to control or improve business operation process (comprising legal affairs operation procedure); a purpose is to solve technical problems of how to apply AI technology to improve quality of business affairs(comprising legal services); a method is executing computer programs and applying AI technology or legal means which follow natural laws; reflection is technical quality standards or specifications; the business operation mode achieves technical effects in line with natural laws, such as AI software or hardware, improving business quality, saving business time, reducing transaction cost or improving social credibility;
wherein the business operation mode provide AI targeted selection services comprising social-intercourse, information, video, live-broadcast, entertainment, games, payment, study, travel, new-retail, life-services, linking legal or business featured services; integrate international, domestic, self-operated, other-operated, e-commerce, store businesses, goods, services; prominent innovation of the legal mode; light assets, heavy talents, heavy mechanisms; revenue priority to commission, promotion, value-added;
wherein an application of technical solution composes 1 system, 3 sub-systems and 13 modules, wherein there are three levels of features, comprising:
foremost macroscopically, relationship characteristics of the three subsystems are as follows: the AI is an empowering platform, legal innovation is a subject soul, business integration is a body frame, the business quality is an ultimate goal;
next mesoscopically, the characteristics of novelty, creativity and practicability oaf the three subsystems are as follows: improving of the AI lies in “double learning” or “double experts”, innovation of legal services lies in the “new brain” or the “new procedures”, improving of goods services lies in “two lines” or “two supports”;
third microscopically, looking from perspective of connecting of three networks of Internet of human, Internet of things, Internet of intelligence, and superposition of AI, legal affairs, business affairs, the technical solution is characterized by improvement on popular universal technology;
characteristics of this business mode technology solution are summarized as follows:
(1) The Artificial Intelligence:
AI is the empowering platform, the improving of the AI lies in the “double learning” or the “double experts”;
(2) The AI+Legal Affairs:
the legal innovation is the subject soul, the innovation of the legal services lies in the “new brain” or the “new procedures”;
(3) The AI+Legal Affairs+Business Affairs:
the business integration is the body frame, the business quality is the ultimate goal, the improving of the business service lies in the “two lines” or the “two supports”.

2. The business operation mode, as stated in claim 1, wherein for the artificial intelligence (1), steps and improvements are as follows:
an AI component module mainly comprises: an input module, a reinforcement learning module and deep learning module, a classification modeling module, a combination module, an output module, an user module and an expert database module; an AI main programs run successively through procedures of service demand, information collection, analysis and processing, classification and integration, data reorganization, solutions, expert interpretation, or expert verification; the most prominent features are the “double learning” in parallel with reinforcement learning and deep learning, the “double experts” in cooperation between an online expert system and offline expert database, particularly the objective impact of different cultural traditions and industry habits;
it is characterized by mainly comprising the following steps:
(1) a user inputs service demand information from the input module to the system, and transmits it to a system of The AI+legal affairs+business affairs, for collecting information about the user's needs;
(2) a reinforcement learning and deep learning module of the AI+legal affairs+business affairs system analyzes and processes the demand information according to the user's service requirements;
(3) the information processed by the reinforcement learning and deep learning modules, is classified and integrated processing according to different types to form modular data;
(4) the AI+legal affairs+business affairs system recombines different modularization data based on the combined module, then applies adaptive algorithms of reinforcement learning and deep learning to process the modularized data to obtain a most accurate and a most suitable solution;
(5) the user reads a most accurate solution and a most suitable solution through an output module of the system, giving priority to approbate or select;
(6) without user approbating, the three-grade experts make interpretation according to a contract to help the user understand, accept, then approbate or select;
(7) if the user fails to approbate it after the interpretation, the three-grade experts make verification according to the contract, then issues the verification or adjudication, and takes effect after delivery;
wherein improvement on the artificial intelligence is:
(8) Internet of human:
experts priority is hobbies, specialties, reputation, online, part-time; “multi-user” connecting of persons, is improved to “all-user” connecting of persons among experts in law, education, health, transportation, and business; connecting of persons is among consumers, growers, producers, service providers, sellers or civil servants; connecting of persons is among natural persons, enterprises or government organizations; connecting of persons is between “all-user” and legal intelligence, intelligence education, intelligence health, intelligence traffic, intelligence business;
(9) Internet of things:
prophase priority to light assets or leases; material connecting of “things and things”, “things and human”, is improved to material connecting of “things and legal affairs”, “things and business affairs”; material connecting is between information perception, intelligence transmission, cloud computing, and enterprise credits, quality standards, production processes; material connecting is of the real world, digital world and intelligent world; and material connecting is with cutting-edge technologies, optimize production processes to improve business quality;
(10) Internet of Intelligence:
prophase follows applied research; an expert system applies double learning, computational law or algorithmic judgment; intelligence connecting of “human and doing things”, is improved to a double-track system of an algorithm for deep learning and reinforcement learning, a double-track system of an AI expert system and expert database with divide-grade and divide-professional, dual-application scenario of aI+legal affairs+business affairs, a dual-application mode of AI social governance and business operation.

3. The business operation mode, as described in claim 2, wherein an AI component module and an AI main programs,
wherein mainly comprising module:
(11) the “double learning”: the reinforcement learning module is parallel with the deep learning module, considering an objective impact of different cultural traditions and industry habits, to form an ideal interval between a most accurate and a most suitable selection according to a strict scientific logic and flexible human experience;
(12) the “double experts”: the online expert system cooperates with the offline expert database to help or complement each other with advantages; the expert system refers to a computer intelligent program system with specialized expertise and experience, the expert database module comprises intermediate, advanced or super grade experts in the business fields of evidence, facts, law;
(13) the expert database: which sets up three professional according to the evidence, fact or law of business, and evaluates three-grade as intermediate, advanced or super grade; to actualize specialization according to computer, finance, commerce, and production, to conduct actual practice according to reconciliation, mediation, or arbitration, and adjudication; to enter a grading database according to academic knowledge, performance evaluation, EQ and IQ, professional test, for annual update evaluation or grading promotion;
wherein mainly comprising programs:
(14) the service demand: mainly comprises business evidence identification, business fact identification, legal application and adjudication; qualification or credit of experts or enterprises, business quality or process control; health care, education training, transportation, goods services and its expansion;
(15) gathering information: information types of the “double learning” are divided into writing, text, drawing, picture, image, voice, audio, video, fingerprint, and face; methods comprise search, identification, interpretation, and understanding; the methods also involves accurate measurement of physical quantities comprising position, velocity, temperature, mass or strain;
(16) expert interpretation, expert verification: experts are professionally divided according to the evidence, facts or laws of business, and are graded according to intermediate, advanced or super grade, for make making transparent interpretation, and helping users to understand or accept; experts conducts interval verification, making evidence verification, fact verification or legal adjudication.

4. The business operation mode, as stated in claim 1, wherein for the AI+legal affairs (2),
mainly comprises sectors of selection of special contract terms, identification of simultaneous evidence fact identification, identification post-event evidence fact, arbitration+reconciliation+mediation of AI+expert, AI's credit assessment+performance guarantee, AI+expert verification of dispute and supervision; a feature is “new brain” of double experts or “new procedure” of reconciliation-mediation-arbitration;
it is characterized by mainly including the comprising programs:
(1) with contract agreed, AI plays a basic role in evidence identification, fact identification, algorithm adjudication or performance guarantee;
(2) with contract agreed, parties give priority to approbate simultaneous evidence or facts of AI reappears or notarization, to voluntarily reconcile as soon as possible in advance;
(3) with contract agreed, first AI evidence is three-grade verified, then AI fact is three-grade verified, experts persuade to mediation;
(4) with contract agreed, experts online trial and three-grade verifies AI adjudication, respecting original intention, mediation first, arbitration afterwards (5) with contract agreed, AI+experts verify corporate credit, control credit limit, guarantee performance or quota transfer;
(6) appropriate time to provide AI+expert verification for evidence, facts and laws, for wrong case correction and victims;
wherein improvement on the AI+legal affairs:
(7) Internet of human:
experts priority is classified, graded, hobbies, specialties, reputation, online, part-time; a single-track system of legal experts, is improved to multiple choice and three-track system of experts from business evidence, facts or law; expert qualification credit confirmation, is improved to a five-track system of qualification credit, genetic inheritance, EQ and IQ, professional testing, performance evaluation; an expert life-long system, is improved to selecting expert database according to divide-grade and divide-professional, annual evaluation promotion, especially online assessment of annual update of professional competency;
(8) Internet of things:
a core business is guaranteed by its own assets; once arbitration, is improved to multiplex mechanisms for multiple voluntary reconciliation priority, three-grade mediation by lawyers, three-grade mediation or adjudication by arbitrator; “first award being the final award”, is improved to AI's multistage of three-grade trial of business evidence, three-grade trial of business facts or of business law; an after-the-fact written evidence, is improved to a two-track system based on simultaneous electronic multimedia evidence; manual registration, delivery or executing, is improved to intelligent online registration, electronic delivery, electronic allocation; abstract recording of the main points of a case, litigation request, evidence, proof, and fact reason, are improved to the actual recording all being truthfully provided by the interested parties and cannot be abridged;
(9) Internet of intelligence:
applied research and basic research are follow or expanded; arbitrators monopolize evidence authentication, factual authentication, or law application, is improved to AI apply algorithm of reinforcement learning and deep learning to carry out evidence identification, fact identification or law application as preconditions; arbitrator-led, and AI-assisted, are improved to AI-led, expert-assisted verification, parties have a chance to apply for upgrading.

5. The business operation mode, as described in claim 4, wherein with contract agreed, AI plays a basic role in evidence identification, fact identification, algorithm adjudication or performance guarantee (1),
it is characterized by mainly comprising the following steps:
(10) the contract authorizes AI to play a pre-basic role: (i) the AI applies reinforcement learning and deep learning, and first makes evidence a most accurate identification A and most appropriate identification B; (ii) then the AI makes the facts a most accurate identification A and the most identification approbation B; finally, the AI makes the law application a most accurate adjudication A and the most appropriate adjudication B;
(11) the contract authorize expert verification to play a selective role: (i) the experts of evidence, facts or legal chooses in an interval between A and B which AI identification or adjudication, selection outside the interval is explained, both parties have a chance to apply for an upgrade; (ii) the experts are responsible for transparency or interpretation of the algorithm to guide both parties to understand or accept it.

6. The business operation mode, as described in claim 5, wherein with contract agreed, parties prior approbate the simultaneous evidence or facts from AI reappearance or notarization, voluntarily reconcile advance in time (2),
it is characterized by mainly comprising the following steps:
(12) the AI plays a fundamental role in synchronizing evidence fact: (i) before dispute, the AI automatically stores important parts, synchronously deposits and preserves them to a notary office online; (ii) after dispute, the AI reappears the electronic data evidence of business transactions for both parties to choose to approbate or reconcile; (iii) if a party fails to approbate it after reappearance, the AI online notarizes it following the agreement, and takes effect after delivery, for both parties to reconcile;
(13) both parties plays a approbation role in synchronizing evidence fact: (i) before dispute, both parties mostly chose AI storage or synchronized notarization deposited; (ii) after AI reappearance, most of the two parties choose to approbate and take effect, and actively voluntarily reconcile after the game; (iii) if a party fails to approbate it after reappearance, the AI notarizes it and takes effect after delivery.

7. The business operation mode, as described in claim 5, wherein with contract agreed, first AI evidence is three-grade verified, then AI fact is three-grade verified, experts persuade to mediation (3),
it is characterized by mainly comprising the following steps:
(14) first, third-grade verifies are provided to post-event business evidence, then reconciles or mediates: (i) after disputes occur, the AI firstly applies reinforcement learning and deep learning to make evidence a most accurate identification A and most appropriate identification B, the game guides most of the two parties to have priority approbate interval or reach reconciliation agreement; (ii) after AI evidence identification, if one party does not approbate it, business evidence experts interpret algorithm online to persuade both parties to understand, to reach a mediation agreement, and take effect after delivery; (iii) if the mediation of business evidence experts fails, selecting and verifying are performed in time within the interval, and explaining the selection is performed outside the interval, which takes effect after delivery; (iv) both parties have a chance to apply for expert verification of business evidence at the middle, high or super grades in turn, and also for upgrade or direct super-grade identification;
(15) then, third grade verifies are provided to post-event business facts, then reconciles or mediates: (i) after the evidence verified, if there is a factual dispute. AI first makes fact a most accurate identification A and the most appropriate identification B, the game guides most of both parties to approbate interval, prioritize reconcile, to reach agreement; (ii) after AI fact identified, without one party approbating, business fact experts interprets the algorithm to persuade both parties to understand, to reach a mediation agreement, and takes effect after delivery; (iii) if the mediation of business fact experts fails, selecting and verifying are performed in time within the interval, and explain the selection is performed outside the interval, which takes effect after delivery; (iv) both parties have a chance to apply for expert verification of business fact at the middle, high or super grade in turn, also for upgrade or direct super-grade verification.

8. The business operation mode, as described in claim 5, wherein with contract agreed, experts online trial and three-grade verifies AI adjudication, respect original intention, mediation first, arbitration afterwards (4),
it is characterized by mainly comprising the following steps:
(16) online application, filing, proof, reply (i) both parties apply for mediation or arbitration online, electronically deliver a notice of acceptance; followed by review within 1 day, electronic delivery of supplementary materials notice; online payment, electronic delivery notice; (ii) both parties provide or exchange evidence online, and electronically deliver evidence receipts; (iii) both sides online defense, application lists the matter, evidence; the other party makes online defense, counter-evidence, electronic delivery of the reply receipt;
(17) lawyers apply law, online reconcile or mediate: (i) both sides have a chance to choose a lawyer without interest or prejudice to mediate, and have a chance to choose a different place; (ii) AI written trials make application of law a most accurate judgment predictions A and the most appropriate adjudication predictions B, most parties are priority to approbate the intervals to reach a reconciliation agreement; (iii) lawyers conduct voice or video mediation online or interpret AI algorithm, giving priority to reaching a reconciliation agreement; if no settlement is reached, both parties have a chance to apply for senior lawyer mediation step by step, or directly for senior or special mediation; if mediation or conciliation fails, a mediation document is made in time, which takes effect after delivery;
(18) arbitrators apply law, reconciliation, mediation or arbitration: (i) both sides have a chance to choose a arbitrator without interest or prejudice, and which takes effect after delivery; choose a different place; (ii) the three arbitrators choose to have long-term trial in work breaks or holidays, saving time or cost; (iii) the AI makes application of law a most accurate adjudication A and the most appropriate judgment B through reinforcement learning and deep learning by combining the data of reconciliation, mediation, verification, prejudge or trial; (iv) the arbitrators interpret the algorithm, persuade to understand or accept, and prioritize to reach a reconciliation agreement, which takes effect after delivery; (v) if the mediation fails, select adjudication is made within the interval in time, and the external demand explanations, which takes effect after delivery; (vi) a final decision takes effect after delivery;, both parties have a chance to apply for upgrade mediation or arbitration before the arbitration is delivered and signed;
(19) arbitrators online video trial: arbitrators, lawyers take the upper body and head video, the party takes the whole body, upper body, head, detail video, synchronized merge video recording, save confidentiality; stereo video input or output software, can be authorized to produce AI hardware;
(20) the adjudication respects the real intention of both parties and electronic encrypted delivers: (i) the facts of the dispute respect the original intention and objective reality of both parties; strictly prevent to delete the case, claims, facts, reasons, evidence, proof, strictly prevent to conceal evidence or reasoning; (ii) the adjudication's documents are confidential, strictly prohibit disclosure electronically deliver, to electronically return.

9. The business operation mode, as described in claim 5, wherein with contract agreed, AI+experts verify corporate credit, control credit limit, guarantee performance and quota transfer (5),
it is characterized by mainly comprising the following steps:
(21) verify credit or control limit: (i) the AI applies reinforcement learning and deep learning to calculate the credit or quality assurance capacity of the responsible subject; financial experts verify the credit limit from the interval, or explain the over-interval; (ii) the AI tracks to verify the credit qualifications of fine manufacturers, sellers, or distributors, providing dynamic charts internally; (iii) a balance is paid with quality responsibility, and exceeding credit limit, requires providing insurance or guarantee;
(22) guarantee performance, line transfer: (i) the AI+experts calculate and select an actual compensation amount, large data cloud calculate a time value and depreciation loss of currency, excluding explanation of benefit from default; (ii) online automatic transfer is used instead of compulsory execution, so as to pay within credit limit instead of cash.

10. The business operation mode, as described in claim 4, wherein appropriate time to provide AI+expert verification for evidence, facts and laws, for wrong case correction and victims (6),
it is characterized by mainly comprising the following steps:
(23) AI investigation and evidence collection, expert verification: (i) when the local legal ecology allows, according to the entrustment, the facts and evidence provided by both parties; (ii) AI collect relevant on-site audio-visual recordings and witness testimony through Internet of human, Internet of things and Internet of intelligence; (iii) refer to the above steps (6) to (11) and (13) to provide new evidence of party approval, AI certification, and expert verification for evidence, facts, and laws of civil, administrative, and criminal disputes, as the certification documents for the initiation of wrongful case correction procedures and the qualification credit of wrongful case victims;
(24) AI investigation and verification, expert verification: (i) when the local legal ecology allows, according to the entrustment and all the case materials provided by the parties; (ii) AI verify and investigate through Internet of human, Internet of things and Internet of intelligence; (iii) refer to the above (6)˜(11 And (13) steps to provide new evidence of party approval. AI certification, and expert verification for evidence, facts, and laws which have been identified in civil, administrative, and criminal disputes, as the certification documents for the initiation of wrongful case correction procedures and the qualification credit of wrongful case victims.

11. The business operation mode, as stated in claim 1, wherein for the AI+legal affairs+business affairs (3),
mainly comprises AI goods services, business expansion, health care, education cultivating, transportation carriage; the mode mainly comprises subject verification, quality verification, nearby stores, indicator analysis, difficult consultation, expert entry, education upgrade, characteristic training, talent training, predictive sensing, navigation video, three-dimensional transportation, open competition, self-improving, merger or reorganization; all accompanied by AI law; a most notable feature is parallel the “two lines” between remote online and nearby offline, and the parallel “two support” between AI and legal services;
it is characterized by mainly comprising the following section:
(1) AI business cloud comprises: enterprise credit and due diligence investigation, quality standards and process control, online or offline stores, line control and transfer;
(2) AI business expansion comprises: AI development, AI legal affairs development, mutual competition with peers, promotion with leaders on the same platform, or hand in hand merger in times of crisis;
(3) AI health care comprises: AI health analysis, information tips, disease treatment advice, video consultation, family hospital medical care, expert door-to-door;
(4) AI education training comprises: AI streamlining curriculum, education upgrading; professional skills abroad, examination training; pressure semester full capacity, talent cultivation;
(5) AI traffic transportation comprises: hierarchical three-dimensional traffic, predictive sensor navigation, functional layered roads, roadside plus floor parking, elevator business hub;
wherein improvement on the AI+legal affairs+business affairs:
(6) Internet of human:
experts priority is region, industry, hobbies, specialties, reputation, online, part-time;
classifying and grad rig operators, enterprises or other users improve assisting small or weak individual business households or enterprises, guiding them to become bigger or stronger; fine enterprise credit qualification confirmation, improves AI verification services for corporate governance, talent team, or due diligence verification; enterprises applying online and providing materials comprising: qualification certificates or operating conditions, improve AI calculation or expert three-grade verification; applying credit qualification information, user evaluation or transaction data of the “all-user” Internet of human to track to adjust, improves providing time dynamic graph; AI comprehensive due diligence investigation replaces financial, tax, legal or business due diligence, and makes disclosure, dynamic adjustment or electronic delivery as required by the transaction of both parties;
(7) Internet of things:
the Internet of things is compatible to other-operated, shop dealers, defective, focus on large-amount, international, B2C; classifying and grading goods, services or other needs, improve on accommodating growth of secondhand goods, low price goods, flea market or underground market, guiding to improve quality or reborn; AI ranking of high quality goods or services, improve link of standard comparison table or cost performance ranking; grading the market according to users, quality or amount, improves the quality grading, with high quality and good price, and channel guarantee for high quality goods or services; selective purchase according to user experience evaluation or entity verification, improve video purchase, travel experience, and training experiment to recommend or identify quality, online and offline at the same price for the same style; AI controls environment facilities or operation process of high quality service, improving divide-professional and divide-grade, qualification, professional expertise of service experts; AI improves controlling production environment, working processing flow and logistics process of high quality products, improving on the origin or raw materials; AI improves services to high-quality goods or services which are located, video-captured, tracked and verified in accordance with the contract;
(8) Internet of intelligence:
comparative application research is followed or expanded, with revenue priority to commission, promotion, value-added, which improve AI calculation, expert three-grade selection of enterprise quality assurance ability, performance compensation capability, and credit limit, while the user have a chance to apply upgrade; improves insurance or guarantee for quality responsibility or performance compensation; and improves timely transfer within the credit limit on line to ensure performance.

12. The business operation mode, as described in claim 11, wherein for the AI business cloud (1) and AI business expansion (2),
the most prominent features are the “two lines” of online e-commerce and offline stores, the “two supports” between AI and legal affairs, the “two considerations” between large sum and foreign trade business, and the “two considerations” between excellent and second-hand quality;
it is characterized by mainly comprising:
(9) providing comprehensive development platform and verifies excellent enterprise credit: (i) classifying and grading operators or enterprises, improve helping the small or weak enterprises or underground economy, to guiding them to become bigger or stronger; (ii) verification of fine enterprise credit qualification, improves tracking verification of corporate governance, talent team or due diligence, providing time dynamic chart;
(10) providing opportunities to make the best use of goods, and to identify high-quality goods services: (i) classifying and grading all goods or services, improve them to comprise flea market, second-hand goods, underground market or low-price goods, guiding to improve their quality or to transform themselves; (ii) the AI classification and gradation of high-quality goods or services, improves connecting of the standard comparison table and the price-performance ranking, strict high quality and high price, providing verification and tracking control of quality, raw or origin materials; (iii) for the underground economy or low price products, both parties shall choose voluntarily, and the AI indicate risk;
(11) providing performance guarantee for quality responsibility: (i) credit ability, credit line of AI calculation, experts three-grade selection; (ii) insurance or guarantee for quality responsibility or performance compensation; (iii) online credit lines transferred in time to ensure performance;
(12) providing global online stores coexist with nearby offline stores: (i) integrate international, domestic, self-operated, other-operated, e-commerce, store, goods, services; prominent the innovation of the legal mode; (ii) remote online stores extend to large amount or foreign-related business or low-priced small commodities; (iii) shops offline near provide online or offline same-quality and same-price, or express delivery at random; (iv) tourism sightseeing, and training practice, improve sense of pleasure or satisfaction of on-site purchase;
(13) applying an AI business operation mode to develop business affairs: (i) provide AI targeted selection services comprising social- intercourse, information, video, live-broadcast, entertainment, games, health, learning, travel, payment, new-retail, life-services, (ii) a business field where computer AI programs have advantages is mainly developed, especially areas where the “double learning” or the “double experts” play an advantage; (iii) underground economy or low price business requires step in to guide the development;
(14) applying an AI+legal affairs business operation mode to expand business affairs: (i) focusing on large amount and foreign related businesses, start from the sectors comprising value-added advertising, health care, education cultivating, transportation carriage; (ii) a business field where the AI legal affairs have advantages is mainly developed, especially advantage fields of the “new brain” or the “new procedures”, or excellent subjects or high-quality; (iii) underground economy or low price business requires step in to guide the development;
(15) providing business sharing leading technology: (i) a remote online store is kept parallel with nearby offline store, wherein the “two lines” help or complement each other with advantages; (ii) the AI applies reinforcement learning and deep learning, and predicts a growth cycle of the enterprise according to operating data of the market, industry and enterprise; (iii) the AI competition platform and profit sharing opportunities are provided for fellow travelers; (iv) a leader competed with to learn on the same stage, to maintain oneself leading edge, and to prevent short-board “bottlenecks”; (v) the AI chooses merger or reorganize for difficult companies with advanced technology, and promptly suggests merger or reorganize for those backward business sectors.

13. The business operation mode, as described in claim 11, wherein for the AI health care (3),
with a certain public service function and social governance mode, the most prominent feature is the “two lines” between online and offline hospitals, the “two supports” between AI and legal affairs, and the “two considerations” between urban and rural medical care;
it is characterized by mainly comprising:
(16) providing online services of AI medical technology: (i) the AI applies reinforcement learning and deep learning to provide a most accurate and most appropriate treatment recommendations; health care experts select from the interval; (ii) input analysis of AI physical examination indicators provides tips for health advice; (iii) AI general disease information input, and diagnosis treatment recommend, experts are signed for verification; (iv) for difficult diseases, AI collects global expert group online video consultation or medical solutions is provided;
(17) providing door-to-door service of AI medical technology: (i) doctors and nurses make an appointment for home treatment, surgery and nursing, who take portable equipment, borrow or rent venues or equipment of rural medical units in counties, so as to make full use of the resources of medical experts in free time; (ii) for difficult diseases or operations, AI collects global expert team online video guidance; (iii) county or rural medical units provide medical examination, information input, diagnosis or treatment services with the AI help;
(18) providing AI expert video virtual medical service: (i) provide patients with health data. and images, and explain abnormal indicators; (ii) provide video and virtual organs for complicated diseases; (iii) provide virtual expert consultation and surgical guidance for the diagnosis and operation of complicated diseases.

14. The business operation mode, as described in claim 11, wherein for the AI education cultivating (4),
with a certain public service function and social governance mode, the most prominent feature is the “two lines” between online and offline school, the “two supports” between AI and legal affairs, and the “two considerations” between elite and mass education;
it is characterized by mainly comprising:
(19) providing AI education training online services: (i) the AI refines or simplifies education upgrading online video, ranking and connecting of similar video; (ii) the AI refines or simplifies videos of graduate students, going abroad, practicing, professional titles, technical skills, ranking and connecting of similar videos; (iii) the AI provides individualized video courses comprising education upgrading, skills, practice, professional titles, or going abroad, to tart with AI baby, review, foreign language, mathematics;
(20) providing effective talents to cultivate special services: (i) after AI personalized analysis, primary, secondary, bachelor's or master's courses are provided, to join life or work skills education; (ii) by taking advantage of the holiday, sound personality training or guide interest during kindergarten, primary school, middle school, bachelor's or master's study are provided,; (iii) the AI refines or simplifies course, to improve teaching efficiency, use AI exercises to fast high score, use three-semester per year to compress system, and cultivate graduate students with sound personality before the age of 20;
(21) providing international innovation elites cultivate services: (i) in primary schools introduce life skills education, provide taking turns to teach in classes around the world to understand the differences of language and cultural; (ii) in secondary school introduce work skills education, provide taking turns internships in various industries to understand the rules of various trades in holidays; (iii) apply AI video, AI exercises to review after class, use three-semester per year compression system, and cultivate innovative elite talents as early as possible.

15. The business operation mode, as described in claim!!, wherein for the AI traffic transportation (5),
with a certain public service function and social governance mode, the most prominent feature is the “two lines” between online and offline traffic, the “two supports” between AI and legal affairs, and the “two layers” between function and space;
it is characterized by mainly comprising:
(22) providing a navigation system of three-dimensional transportation: AI sky-eye navigation map+sensor video, stereo-navigates car to travel or to park, so as to improve efficiency: (i) using monitoring data of vehicle flow or stock, providing a sky-eye system of time-space distribution of recent traffic of cars, wherein AI chooses to navigate the cars to travel or go into storage to avoid congestion; (ii) applying a technology of driverless cars to provide a sensing system for an environment around the road of the cars, which automatically navigates or rests on its own; (iii) providing a logistics channel control system for line positioning or handover of video;
(23) providing stratification system of the three-dimensional transportation: which builds more than six floors of roads or parking spaces with functional stratification in large cities, to increase area or save costs; a municipal project is combined with a private market, the municipal public transportation is below fourth floors, and the private market is above the fourth floors; detailed see the attached FIG. 3;
stratification roads for example: (i) the first floor: a free layer for pedestrians or heavy vehicles (wherein aerial trains are added above);
(ii-iii) the second-third floor: a bus layer for subways, trams or buses transports(same below);
(iv-vi) the fourth-sixth floor: a self driving layer for rentals, cars or public buses (same below);
(vii) the seventh floor: a shopping consumption layer (wherein parking lots are added);
(viii) the eighth floor: sightseeing leisure layer (wherein cable cars are added above);
stratification parking spaces for example: (i) stratification-added parking spaces: 2-3 simple three-dimensional parking space are built between stratification road; (ii) automobile residential building: several high-rise “automobile residential buildings” with elevators can be designed and built on the side of stratification roads according to different tonnages as a whole;
(24) providing a garage and hub elevator system of three-dimensional transportation: (i) hub system: green separation belts and up and down elevators can be built on the roadside of intersections and hub locations (shopping malls and parking spaces); (ii) elevator system: waterwheel elevators with multi-car can be built between shopping malls, garages, parking spaces and roads, and can transport pedestrians and cargo; (iii) car robot: AI control, compact and flexible, allocates parking spaces according to time and space, ranking and carrying into or out of the garage;
and cooperate with elevator to transport vehicles up and down or turn around.

16. The business operation mode, as described in claim 15, wherein for the AI waterwheel elevator (24),
it is characterized by mainly comprising:
the main structure comprises four space parts comprising machine room, well and pit, car, layer station, including eight systems comprising traction, guidance, car, door, weight balance, electric drive, electrical control, safety protection; the following improvements are made by using the principle of water wheel and AI technology:
(25) waterwheel elevator: (i) four comers of the car, 0.1-0.8 m front and rear, and 1 to 3 m above, use four drawing wire ropes to share the parallel pulling force; (ii) annular wire rope, four parallel right-angle steering and traction force systems are set at the upper and lower ends of left, right, before and after; and fixed position and anti-falling lock system are set at the force awarding place of each layer; (iii) six sides of the car, with passenger closure priority, with cargo (vehicle) semi-closed priority, the spacing between semi-closure and the well should be controlled within 0.1 m; (iv) direction of entry and exit: left and right separation for passenger, the passenger moves clockwise, and the cargo robot can help to move forward and backward, left and right; (v) number of hanging boxes: according to the time and space distribution of flow, the maximum number of hanging boxes for customers is one per floor, and the maximum number of hanging boxes for cars is two or three per floor;
(26) AI elevator: (I) safety identification: The resident owner of a certain floor, shall reserve basic information comprising identity, number and mobile phone, and reserve identification information comprising fingerprints, audio and video (face, pupil), AI verify to release; (ii) guests appointment: a temporary visitor on a certain floor, register information comprising identity, number, audio and video, then swipe the ID card and pay the deposit electronically, AI identify to release; (iii) AI in and out: with inbound and outbound communication information system, AI timely calculated, coordinated, and quick arrange and assist; the owner master timing, fixed point in and out, shall book and pay in advance three or five minutes; (iv) quota budget: the owner's quota are determined based on frequency and rate, pay at a discount when paying the property fee, the original payment will be returned after the host pays the guest; (v) man-machine guarantee: not only set up the power guarantee system, but also prepare the generator to deal with power outages, besides, can shut down AI system, start the configured mechanical power, and manually control the system.
